(19) United States
(12) Patent Application Publication
(10) Pub. No.: US 2010/0125515 A1
(43) Pub. Date: May 20, 2010

(54) Fund management system

(75) Inventors: Makoto Aso, Nagareyana-shi (JP); Tomoyuki Kubo, Himeji (JP); Kazuki Ishino, Himeji (JP); Hirofumi Ozaki, Tokyo (JP); Hideki Aniya, Himeji (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: GLORY LTD., a corporation of Japan, Himeji-shi (JP)

(21) Appl. No.: 12/291,975

(22) Filed: Nov. 14, 2008

(51) Int. Cl. G06Q 40/00

(52) U.S. Cl. 705/35

(57) ABSTRACT

A fund management system comprises a banknote and coin handling system which handles a banknote and a coin, a check handling apparatus which handles a check, a lobby deposit handling apparatus which executes a lobby deposit process, a money change handling apparatus which changes the money, and a server which manages the banknote and coin handling system, the check handling apparatus, the lobby deposit handling apparatus, and the money change handling apparatus.

### TECHNICAL FIELD OF THE INVENTION

The present invention relates generally to a fund management system used in financial institution. More particularly, the present invention relates to a fund management system including a banknote and coin handling system, a check handling apparatus, a lobby deposit handling apparatus, and a money change handling apparatus.

### BACKGROUND OF THE INVENTION

The financial institution such as a bank deals with a variety of currencies such as the loose banknotes, the bundled banknotes, the loose coins and the packed coins.

A banknote-related handling apparatus (refer to, e.g., Japanese Patent Application Laid-Open Publication No. 2003-141598) and a coin-related handling apparatus (refer to, e.g., Japanese Patent Application Laid-Open Publication No. 2005-228079) have hitherto been developed, and a banknote-and-coin handling system is built up by arranging these single-function apparatuses in a side-by-side relation.

The conventional banknote-and-coin handling system does not, however, unify sizes and functions of these single-function apparatuses, resulting in such problems that space efficiency does not reach an acceptable level, the necessary functions are not realized in some case, and the operations are so complicated as to induce mistakes.

Further, as in the case of the banknote-and-coin handling system installed in a cashier room, the verification has hitherto been performed one or twice a month. In this case, there exists a problem that a person in charge of the banknote-and-coin handling system unlawfully takes and brings the cash out of the banknote-and-coin handling system by use of a key, then temporarily borrows the cash from another banknote-and-coin handling system only when verified, subsequently inputs the cash into a storage box by employing the key, and conducts the verification in a way that pretends a normal state of the verification result, thus performing the unlawful act.

In terms of storing tremendously a large amount of moneys in the banknote-and-coin handling system installed in the cashier room, it is quite time-consuming to discriminate between and count all the moneys by feeding the moneys out of the storage box on a one-by-one basis and to return the moneys into the storage box. This operation entails stopping banking operations under the verification if conducted in the operation time, and it follows that the verification is carried out after finishing other operations. Generally, the banking operations are not finished till the verification is terminated, and hence there is a problem that the person, as a matter of course, in charge of the banknote-and-coin handling system and all the bank clerks are restricted late in the night depending on the situation.

Further, if a fault (such as a deficiency in the number of banknotes and coins, and a mixture of abnormal banknotes) would occur in the banknote bundle later on due to a mistake of an operator (a person in charge of treatment), a follow-up examination for specifying a cause thereof etc is needed. The follow-up examination can not be, however, easily conducted based on only information such as a serial number.

If failing to clear sum-up data and to switch OFF a power source concurrently, the data has hitherto been enabled to be inputted even when the date changed, in which case a problem is that the deposit and dispensation processes are performed without being aware of the abnormal state.

Still another problem is that a recovery process from the deficiency of the cash under the dispensation and occurrence of a trouble in a lobby machine etc takes a considerable period of time, with the result that the customers must wait. Yet another problem is that the person in charge implements calculations when in the recovery process, and therefore the efficiency decreases.

Furthermore, a scheme in the prior art is that in the case of executing the deposit and dispensation processes and the dispensation process in parallel, if a banknote jam occurs during any one of both processes, the clerk in charge removes the jammed banknotes and the banknotes in the middle of being carried after finishing the other process, and another process may resume. If the banknote jam occurs likewise during the other process, however, the clerk in charge must discriminate between the jammed banknotes and the banknotes in the middle of being carried into deposit banknotes and dispensation banknotes and then must remove these banknotes. If a misjudgment is made, such a problem arises that a variety of discrepancies in calculations occur.

Furthermore, a fund management system used in financial institution includes a banknote and coin handling system, which is installed at an operation branch, and a server, which is installed at a center. However, the server is not connected to the other apparatuses (for example, a check handling apparatus, a lobby deposit handling apparatus, and a money change handling apparatus). Therefore, total amount of money or total number of banknotes and coins of the other apparatuses are managed, independently to that of the banknote and coin handling system. As a result, it is problem that a management of all funds of every operation branches is complicated.

### SUMMARY OF THE INVENTION

Under such circumstances, it is an object of the present invention to provide a fund management system for making the management of all funds of every operation branches easy.

For the present invention, there is provided that a fund management system of the present invention comprising:

a banknote and coin handling system which handles a banknote and a coin;

a check handling apparatus which handles a check;

a lobby deposit handling apparatus which executes a lobby deposit process;

a money change handling apparatus which changes the money; and

a server which manages the banknote and coin handling system, the check handling apparatus, the lobby deposit handling apparatus, and the money change handling apparatus.

For the present invention, it is preferable that the fund management system comprising:

a storage unit provided with a stacker; and

a memory which stores check data of the check stored in the storage unit;

the server which acquires the check data stored in the memory.

For the present invention, it is preferable that the check handling apparatus further comprising a post which stores a medium that cannot be stored in the storage unit;

the check data includes total amount of money or total number of checks of the post.

For the present invention, it is preferable that the check data includes at least one of the total amount of money or total number of checks of the storage unit, and amount of money or number of checks of each check.

For the present invention, it is preferable that the check handling apparatus further comprising a reading unit which reads image information of the check;

the check data includes the image information read by the reading unit.

For the present invention, it is preferable that the server acquires a state of the check handling apparatus.

For the present invention, it is preferable that the server acquires processed data of the check handling apparatus.

For the present invention, it is preferable that the server acquires closing information of the check handling apparatus.

For the present invention, it is preferable that the server acquires a reconciliation result of the check handling apparatus.

For the present invention, it is preferable that the storage unit comprising a plurality of stackers which store the checks by type.

For the present invention, it is preferable that the check data includes at least one of the total amount of money or total number of checks of each stacker, total amount of money or total number of checks of all stackers, and amount of money or number of checks of each check.

According to the present invention, there is provided that the fund management system realizes unified management of all funds of the operation branches.

### BRIEF DESCRIPTION OF THE DRAWINGS

FIG. 1 is a perspective view showing an external appearance of a banknote and coin handling system in one embodiment of the present invention;

FIG. 2 is a perspective view showing an external appearance of the banknote and coin handling system in a modified embodiment illustrated in FIG. 1;

FIG. 3 is a perspective view showing an external appearance of the banknote and coin handling system in another modified embodiment illustrated in FIG. 1;

FIG. 4 is a perspective view illustrating only banknote handling components in FIG. 1;

FIG. 5 is a vertical sectional view schematically showing an internal structure of a bundle sorting dispensation unit in a banknote handling apparatus illustrated in FIG. 1;

FIGS. 6A and 6B are enlarged views of a peripheral portion (when in a banknote bundle storage process) of a banknote bundle carrying path in the bundle sorting dispensation unit shown in FIG. 5; FIG. 6A is a plan view; and FIG. 6B is a vertical sectional view;

FIGS. 7A and 7B are enlarged views of the peripheral portion (when in a banknote bundle ejecting process) of the banknote bundle carrying path in the bundle sorting dispensation unit shown in FIG. 5; FIG. 7A is a plan view; and FIG. 7B is a vertical sectional view;

FIG. 8 is a plan view showing an operation of a nipping portion of a bundle carrying unit common to the bundle sorting dispensation unit and a loose banknote deposit and dispensation unit in terms of a relation with part of the respective handling units;

FIG. 9 is a vertical sectional view schematically illustrating an internal structure of the loose banknote deposit and dispensation unit in the banknote handling apparatus illustrated in FIG. 1;

FIG. 10 is a schematic view of the internal structure, showing an internal structure of a new banknote dispensation unit shown in FIG. 1 and a flow of the banknotes;

FIGS. 11A-11C are views showing in sequence how an out-of-machine bundle loading process is executed by a banknote bundle handling unit illustrated in FIG. 5;

FIGS. 12A-12C are views showing in sequence how an auto careful inspection process is executed by the banknote bundle handling unit illustrated in FIG. 5;

FIGS. 13A-13C are views showing in sequence how an auto allocation process is executed by the banknote bundle handling unit illustrated in FIG. 5;

FIG. 14 is a vertical sectional view schematically showing an internal structure of a coin handling unit partly constituting the banknote and coin handling system illustrated in FIG. 1;

FIG. 15 is a plan view schematically showing a main configuration in FIG. 14;

FIG. 16 is a side view showing a layout of coin storage portions of the lose coin deposit and dispensation unit;

FIG. 17 is a sectional view of the main configuration related to storing wrapped coins as viewed from a right side front side in FIG. 14; and

FIG. 18 is a perspective view showing one example of a wrapped coin storage portion.

FIG. 19 is a block diagram showing a configuration of the fund management system according to the present invention.

FIG. 20 is a vertical sectional view showing an internal structure of the check handling apparatus 300 illustrated in FIG. 19.

FIG. 21 is a block diagram showing a configuration of the lobby deposit handling apparatus 400 illustrated in FIG. 19.

FIG. 22 is a vertical sectional view schematically showing an internal structure of a coin section 420 illustrated in FIG. 21.

FIG. 23 is a vertical sectional view schematically showing an internal structure of a banknote section 440 illustrated in FIG. 21.

FIG. 24 is a block diagram showing a configuration of the money change handling apparatus 500 illustrated in FIG. 19.

FIG. 25 is a vertical sectional view schematically showing an internal structure of a banknote section 520 illustrated in FIG. 24.

FIG. 26 is a vertical sectional view schematically showing an internal structure of a loose coin section 540 illustrated in FIG. 24.

FIG. 27 is a vertical sectional view schematically showing an internal structure of a wrapped coin section 560 illustrated in FIG. 24.

FIG. 28 is a sequence diagram showing an outline of the management function of the total amount of money and/or total number of banknotes, coins, and checks of the fund management system.

FIG. 29 is a sequence diagram showing an outline of the near-full/near-end management function of the fund management system.

FIG. 30 is a sequence diagram showing an outline of the management table function of the fund management system.

FIG. 31 is a sequence diagram showing an outline of the data inquiry function of the fund management system.

FIG. 32 is a sequence diagram showing an outline of the closing management function of the fund management system.

FIG. 33A is a sequence diagram showing an outline of the operation management function (a management function of master information) of the fund management system.

FIG. 33B is a sequence diagram showing an outline of the operation management function (a modification function of a data) of the fund management system.

FIG. 34 is a sequence diagram showing an outline of the automatic reconciliation function of the fund management system.

### DETAILED DESCRIPTION OF THE EXEMPLARY EMBODIMENT

An in-depth description of an embodiment of a banknote and coin handling system according to the present invention will hereinafter be made.

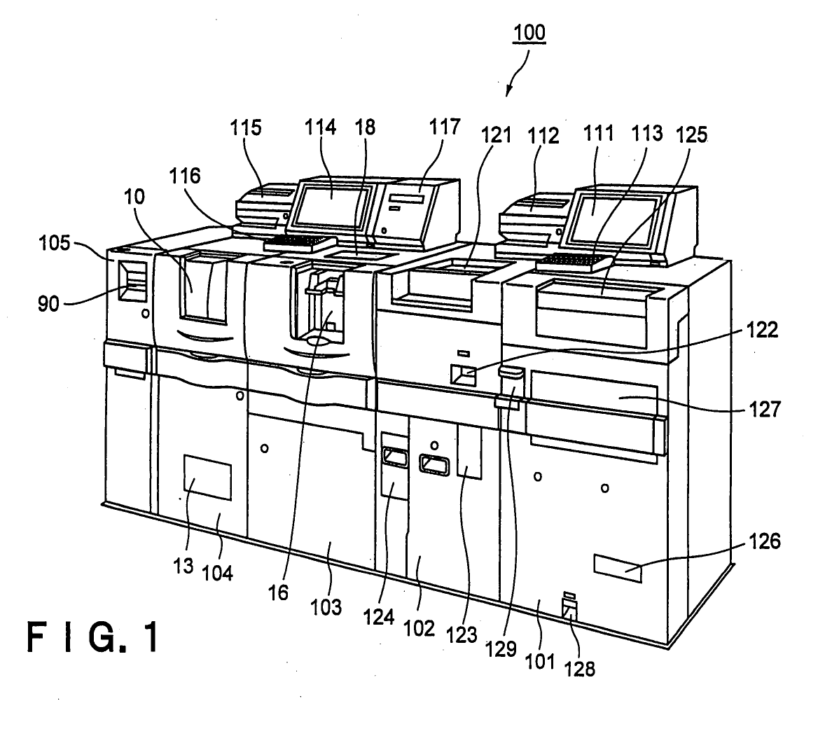

FIG. 1 is a perspective view illustrating architecture of a whole banknote and coin handling system 100 according to the present invention. The banknote and coin handling system 100 is a side-by-side installment type of banknote and coin handling system including five handling apparatuses 101-105 that are connected to each other. The handling apparatuses 101-105 are, from the right side, a packaged coin dispensation unit 101, a loose coin deposit and dispensation unit 102, a loose banknote deposit and dispensation unit 103, a bundle sorting dispensation unit 104 and a new banknote dispensation unit 105. The loose banknote deposit and dispensation unit 103, the bundle sorting dispensation unit 104 and the new banknote dispensation unit 105 build up a banknote machine for depositing, dispensing, and sorting, and the packaged coin dispensation unit 101 and the loose coin deposit and dispensation unit 102 build up a coin machine for depositing, dispensing, and sorting.

The respective apparatuses are coincident in terms of heights of their housings, and can be connected to each other with a sense of uniformity. It is desirable that depths of the individual apparatuses be equalized. The three banknote-oriented apparatuses and the two coin-oriented apparatuses can be respectively connected, and a system arrangement may be done irrespective of a right-and-left positional relation between the banknote-oriented units and the coin-oriented units. Therefore, the architecture in FIG. 1 can be changed without any restrictions according to the necessity, such as a layout of replacing the banknote-oriented units and the coin-oriented units with each other.

Upper surfaces of the housings of the packaged coin dispensation unit 101 and the loose coin deposit and dispensation unit 102 are provided with a terminal unit 111 for displaying and operating a screen, a printer unit 112 that performs printing and a keyboard 113. Upper surfaces of the housings of the loose coin deposit and dispensation unit 102 and the loose banknote deposit and dispensation unit 103 (the loose banknote deposit and dispensation unit 103 and the bundle sorting dispensation unit 104) are likewise provided with a terminal unit 114, a printer unit 115 and a keyboard 116. Provided further is a post unit 117 into which unfit banknotes, checks, etc are inserted.

The present embodiment involves providing the terminal units and the printer units by twos, however, these units are the same other than such setting that one units are used as main units while the others are employed as sub-units.

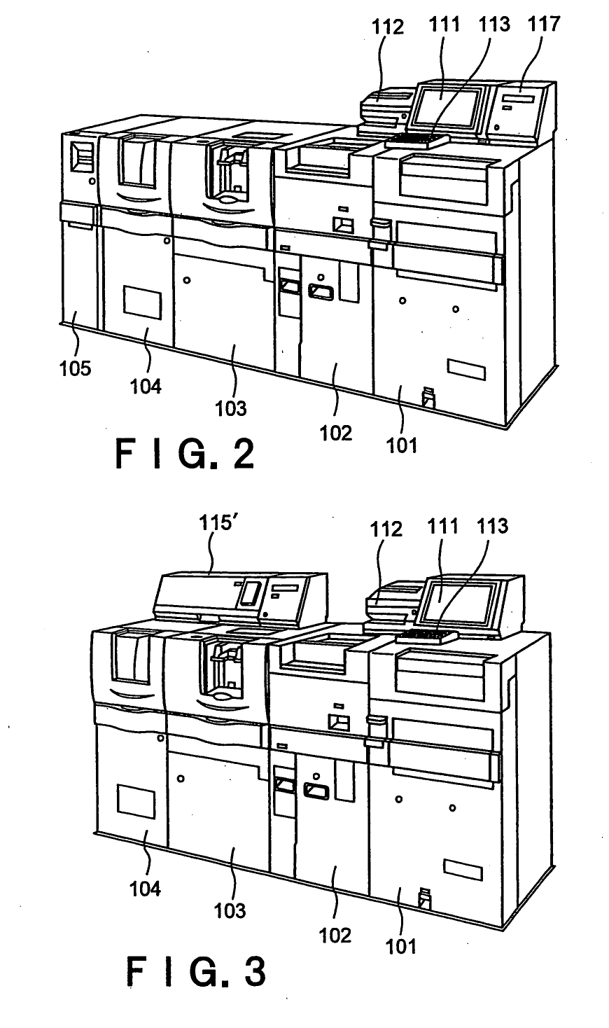

Accordingly, as illustrated in FIG. 2, the system can be so configured as to include only one set of the terminal unit 111, the printer unit 112, keyboard 113 and the post unit 117.

Note that the new banknote dispensation unit 105 is illustrated by way of an example of a vertical placement type in FIGS. 1 and 2, and can be also placed as a lateral placement type 105′. In this case, an occupied area can be reduced, and the terminal unit 111, the printer unit 112 and the keyboard 113 are provided by ones in terms of the space.

Each of the handling units will hereinafter be described.

### 1. Banknote Handling Unit

As described above, the banknote and coin handling system 100 according to the present invention is roughly constructed of the loose banknote deposit and dispensation unit 103, the bundle sorting dispensation unit 104, the new banknote dispensation unit 105, the packaged coin dispensation unit 101 that deals with the coins and the loose coin deposit and dispensation unit 102. In the following discussion, however, the loose banknote deposit and dispensation unit 103, the bundle sorting dispensation unit 104 and the new banknote dispensation unit 105, which build up the banknote machine for depositing, dispensing, and sorting of the banknote-oriented units, will be explained.

### (1) Bundle Sorting Dispensation Unit 104

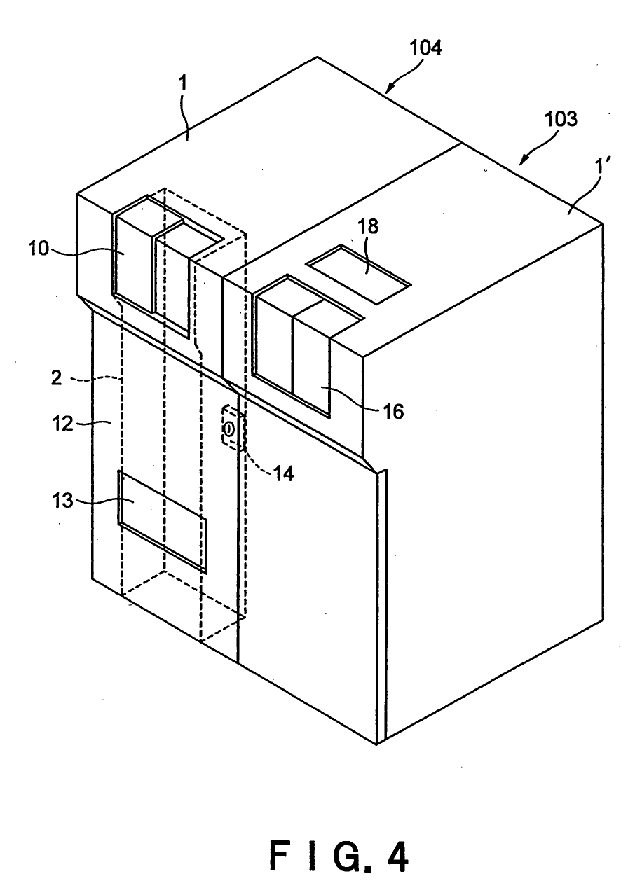

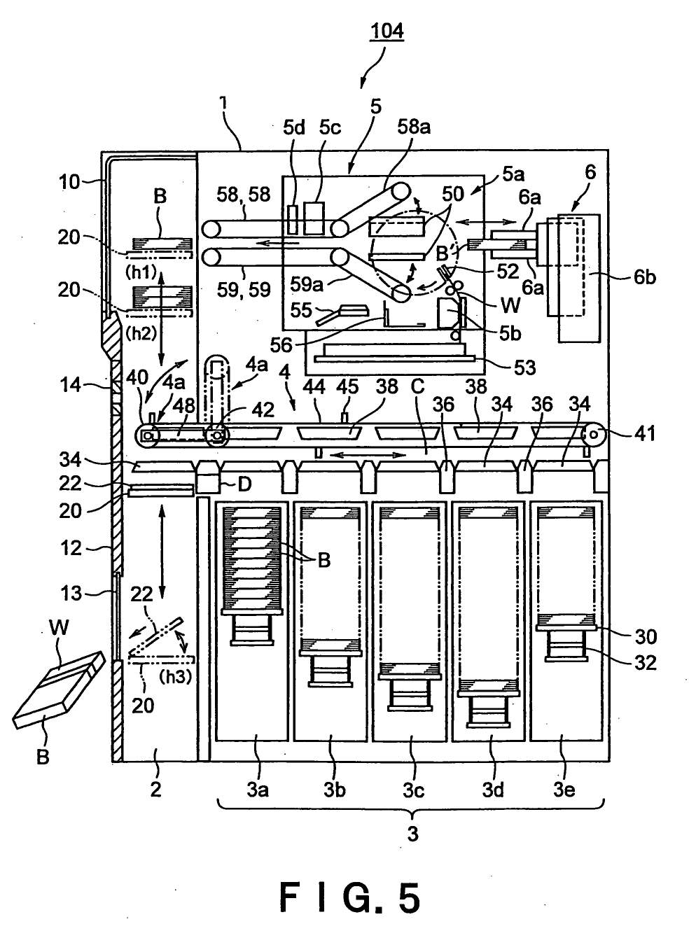

FIG. 1 illustrates an external appearance of the whole system. FIG. 4 illustrates external appearances of the loose banknote deposit and dispensation unit 103 and the bundle sorting dispensation unit 104. FIG. 5 schematically illustrates an internal structure thereof. As shown in FIGS. 1, 4 and 5, the bundle sorting dispensation unit 104 includes a bundle carrying unit 6 (which will be described later on) for carrying in a loose banknote bundle B′ from the loose banknote deposit and dispensation unit 103 that will be explained later on, a binding print unit 5 that binds a predetermined number of loose banknote bundles B′ with a binding band (binder) W into a banknote bundle B and performs a predetermined print on the binding band W, a banknote bundle ascending and descending path (banknote bundle accepting unit) 2 for moving the banknote bundle B undergoing the binding and printing process by the binding print unit 5 in a vertical direction, and a banknote bundle storage unit 3 that stores the banknote bundles B. Further, the bundle sorting dispensation unit 104 includes a carrying unit (loading unit) 4 that moves the banknote bundle B in a horizontal direction between the ascending and descending path 2 and the storage unit 3, and a bundle discriminating unit (discriminating unit) D that discriminates between denominations of the banknote bundles B carried by the carrying unit 4.

A housing 1 illustrated in FIG. 5 houses the ascending and descending path 2, the storage unit 3, the carrying unit 4 and the binding print unit 5, and the bundle carrying unit 6 moves within the housing 1 (and a housing 1′ for the loose banknote deposit and dispensation unit 103, which will be described later on).

The banknote ascending and descending path 2 is disposed along the front side of the housing 1, and is provided inside with an ascending and descending stage (loading unit) 20 that ascends and descends while being loaded with the banknote bundles B. An inclined plate 22 swingable to tilt the front is provided on an upper surface side of the ascending and descending stage 20. An upper portion of the ascending and descending path 2 is communicable with the outside via a shutter opening and closing type of a bundle dispensation port 10. Moreover, a lower part of the ascending and descending path 2 is opened on the whole by opening forward an opening and closing door 12 attached with a locking device 14 and is also communicable partially with the outside via a shutter opening and closing type of a bundle out-of-machine ejection port 13 provided at the opening and closing door 12.

The banknote bundle storage unit 3 has five bundle storage portions 3a-3e disposed in line in back-and-forth directions. The bundle storage portions 3a-3e are classified into the four denomination bundle storage portions 3a-3d for storing the banknote bundles B on a denomination-by-denomination basis and the batch manner bundle storage portion 3e for storing batch manner the banknote bundles B in a multi-denomination state. Note that the functions of the respective storage portions and the denominations can be flexibly set and changed, and it is feasible to provide a plurality of storage portions for specified denominations and provide a plurality of batch manner storage portions.

Each of the bundle storage portions 3a-3e is of an independently attachable and detachable cassette type, with its upper end portion being opened, and is provided inside with an ascending and descending stage 300 fitted with a pantograph mechanism 32.

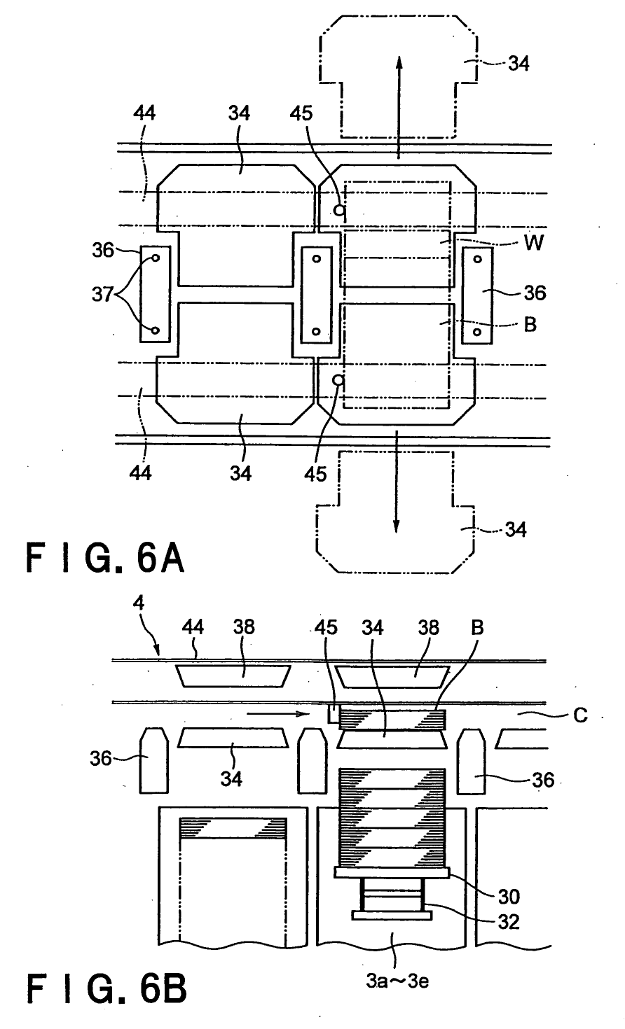

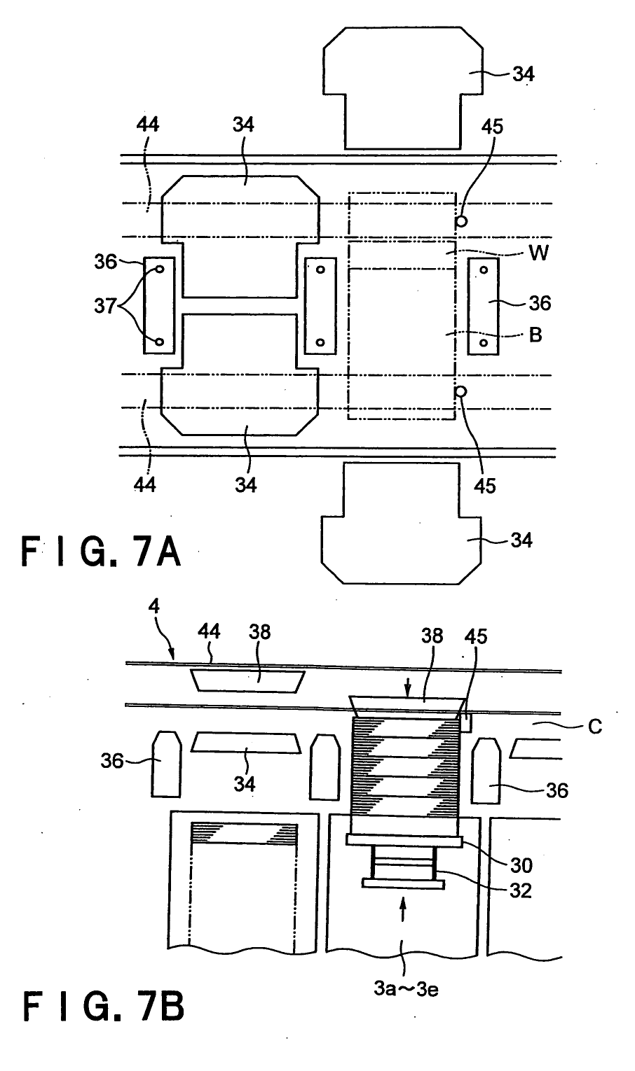

FIGS. 6 and 7 are diagrams each showing in enlargement peripheral portions of the banknote bundle carrying path in the banknote handling unit illustrated in FIG. 5 when inserting the banknote bundle and when ejecting the banknote bundle. FIGS. 6A and 7A are plan views, and FIGS. 6B and 7B are vertical sectional views.

The carrying unit 4 has a pair of left-and-right conveying belts 44 (see FIG. 6A) extending horizontally to within the ascending and descending path 2 from above the storage unit 3. Each conveying belt 44 is stretched between a pair of pulleys 40, 41 and is provided with four pieces of pins 45 protruding at predetermined intervals. For each of the conveying belts 44, a third pulley 42 is disposed between the pair of pulleys 40, 41 (just posterior to the ascending and descending path 2). Then, a lever 48 connecting the two pulleys 40, 42 on the side of the ascending and descending path 2 is swingable through 90 degrees upward about an axis of rotation of the pulley 42. With this contrivance, the portion, on the side of the ascending and descending path 2, of the carrying unit 4 swings to a vertical retreat position from a horizontal carry position, thereby forming a swing retreat portion 4a enabling the retreat from within the ascending and descending path 2.

A pair of opening and closing plates 34 (see FIG. 6) opening and closing rightward and leftward is provided respectively between the carrying unit 4 and each of the bundle storage portions 3a-3e. Moreover, a pair of opening and closing plates 34 is similarly provided between the swing retreat portion 4a of the carrying unit 4 and the lower part of the ascending and descending path 2. A partition plate 36 is provided respectively between the opening and closing plates 34 corresponding to the individual bundle storage portions 3a-3e. A pair of sensors 37 (FIG. 6A) for detecting passage and a skew of the banknote bundle B is provided on an upper edge face of each partition plate 36. The bundle discriminating unit D is disposed between the opening and closing plate 34 on the bundle storage portion 3a and the opening and closing plate 34 within the ascending and descending path 2.

A carrying path C along which to convey the banknote bundle B in the horizontal direction is formed between the opening and closing plate 34, the partition plate 36, the bundle discriminating unit D and the carrying unit 4. To be specific, the banknote bundle B, which receives carrying force from a pin 45 of the conveying belt 44 within the carrying path C, is carried while sliding on the opening and closing plate 34 etc (see FIG. 5). Note that a pressing force detection plate 38 in a face-to-face relationship with the opening and closing plate 34 on each of the bundle storage portions 3a-3e is disposed between the pair of conveying belts 44.

Herein, an explanation of how the banknote bundle B is inserted into and ejected from each of the bundle storage portions 3a-3e, will be made with reference to FIGS. 6 and 7. Note that the discussion will proceed in a way that does not specify any one of the bundle storage portions but generically applies the bundle storage portions 3a-3e in FIGS. 6 and 7.

When storing the banknote bundle B as shown in FIG. 6, to begin with, the banknote bundle B is carried by the carrying unit 4 to above the opening and closing plates 34 corresponding to the should-be-stored bundle storage portions 3a-3e. On the other hand, within the bundle storage portions 3a-3e, the ascending and descending stage 30 rises to a height at which to receive the banknote bundle B to be stored (FIG. 6B). In this state, the pair of opening and closing plates 34 is opened rightward and leftward (FIG. 6A), thereby dropping the banknote bundle B down onto the ascending and descending stage 30 (on the banknote bundle B stacked on this stage 30). Thereafter, the pair of opening and closing plates 34 is closed, and the ascending and descending stage 30 descends to a predetermined position, thus completing the storage of the banknote bundle B.

Next, when ejecting the banknote bundle B as shown in FIG. 7, the opening and closing plates 34 above the bundle storage portions 3a-3e from which the banknote bundle B should be ejected, open rightward and leftward, and the ascending and descending stage 30 on which the banknote bundle B is placed ascends. At this time, the pressing force detection plate 38 descends synchronizing with the opening of the opening and closing plates 34 and regulates a rising height of the banknote bundle B. To be specific, the pressing force detection plate 38, when pushed up by the uppermost banknote bundle B, functions as a switch that stops the ascendance of the stage 30. With this operation, only the uppermost banknote bundle B can be ejected onto the carrying path C, thus enabling the banknote bundles B to be carried on a bundle-by-bundle basis by the carrying unit 4.

Subsequently, the binding print unit 5 illustrated in FIG. 5 includes a binding unit 5a for binding a loose banknote bundle B′ carried by the bundle carrying unit 6 with a binding band W into the banknote bundle B, and a printer (printing unit) 5b for performing a predetermined print etc on the binding band W of the banknote bundle B. The binding unit 5a has a nipping unit 50 that nips the loose banknote bundle B′, and a rotary arm 52 for winding the binding band W (drawn from a roll 53) around the nipped bindle B′. This binding unit 5a can involve using a known type of binding device. The binding unit 5a has, in addition, a bonding trowel 55 that bonds the edges of the wound binding band W, and a cutter 56 that cuts the binding band W on the bundle-by-bundle basis. Note that a band winding position of the bundled banknotes is changeable because of differences depending on countries, districts, etc.

Then, a content of how the band is wound can be changed depending on a characteristic of the banknotes that should be bundled. For example, a positional change of winding the bands around fit (normal) banknotes and unfit banknotes facilitates the banknote management within a financial institution, and hence, for example, it is possible to control winding the band around the fit banknotes in a position slightly deviating from the center and around the unfit banknotes at the center.

Further, a sheet of winding band paper may be fixed irrespective of the denominations, however, it is feasible to facilitate distinction between the denominations of the bundled banknotes and the banknote management as well by use of the sheets of winding band paper different according to the categories of the denominations in a way that enables plural types of winding band paper to be supplied.

In another mode, the same winding band paper is applied to each of the denominations, and a post-bundling winding band paper can be marked with a color corresponding to the denomination.

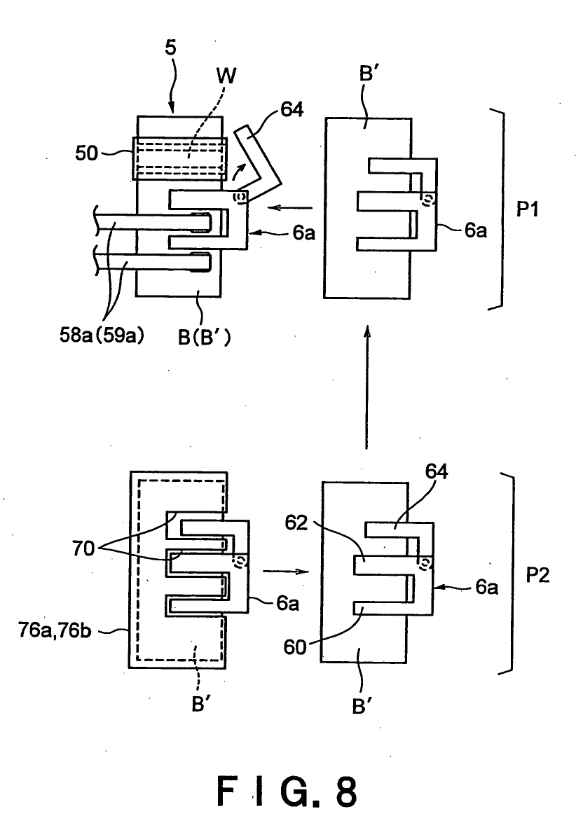

Further, the binding print unit 5 is provided with conveying belts 58, 59 for conveying the tied-up banknote bundle B to the upper portion of the ascending and descending path 2. An institution name stamp 5c for printing a name of the financial institution on the binding band W of the banknote bundle B and an unfit banknote stamp 5d for pressing an unfit banknote mark on the binding band W that binds the unfit banknotes, are disposed neighboring to the upper conveying belt 58 thereof. Note that swing retreat portions 58a, 59a (see FIG. 8) retreating to the outside when winding the binding band W are formed on the sides corresponding to nipping portions 50 of the conveying belts 58, 59.

It is to be noted that the carrying unit 4 is not limited to the unit employing the conveying belt 44 fitted with the pin 45 described above and may, if capable of moving the banknote bundle B in reciprocation along the carrying path C, take other constructions. Moreover, the bundle sorting dispensation unit 104 can be made independent as, e.g., a device that process only the already tied-up banknote bundle, and, in this case, it is possible to omit the binding print unit 5 and bundle carrying unit 6 in separation from the loose banknote deposit and dispensation unit 103. Moreover, the banknote bundle storage unit 3 may include, without being limited to the configuration having only one batch manner storage portion 3e, a plurality of batch manner bundle storage portions.

Herein, the bundle carrying unit 6 common to the bundle sorting dispensation unit 104 and to the loose banknote deposit and dispensation unit 103 will be described with reference to FIGS. 5 and 8. The bundle carrying unit 6 includes a pair of upper and lower nipping portions 6a that nip the loose banknote bundle B′, and a moving portion 6b (FIG. 5) that moves these nipping portions 6a. The moving portion 6b of the bundle carrying unit 6 moves the nipping portions 6a backward and forward in the front-and-rear directions, and moves the nipping portions 6a in the right-and-left directions between the bundle sorting dispensation unit 104 and the loose banknote deposit and dispensation unit 103. Each of the nipping portions 6a has, as illustrated in FIG. 8, three pieces of nipping pawls 60, 62, 64 extending forward. The right-end nipping pawl 64 thereof is enabled to swing-retreat backward in order to avoid interference with the nipping portions 50 of the binding print unit 5 in the bundle sorting dispensation unit 104.

### (2) Loose Banknote Deposit and Dispensation Unit 103

Next, a specific construction of the loose banknote deposit and dispensation unit 103 illustrated in FIG. 1 will be explained.

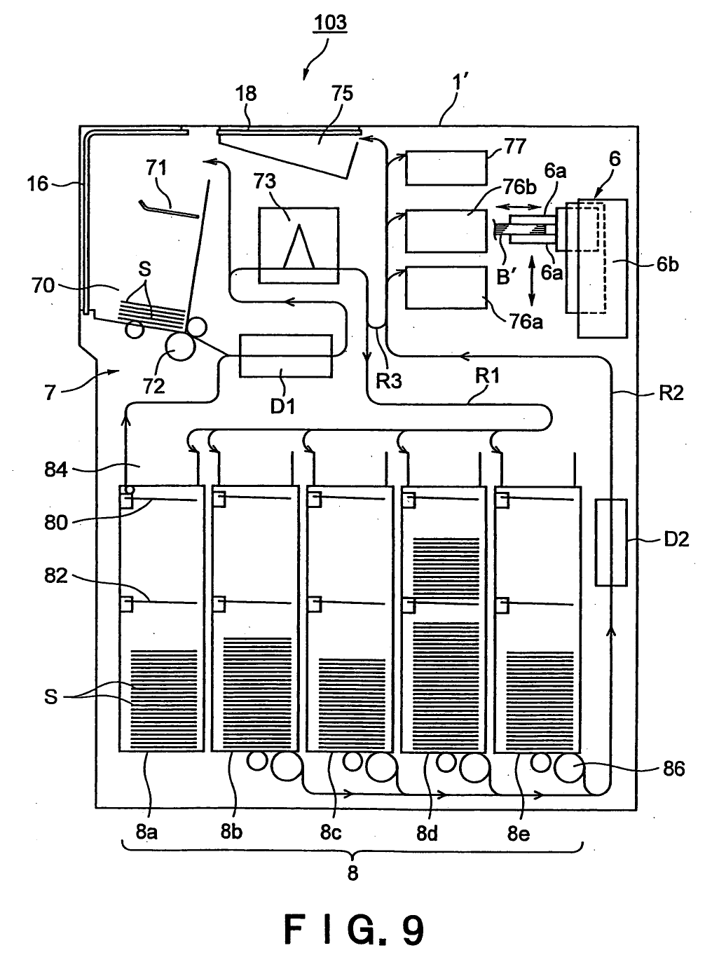

FIG. 9 schematically shows an internal structure of the loose banknote deposit and dispensation unit 103. Referring to FIG. 9, the loose banknote deposit and dispensation unit 103 includes a deposit and dispensation handling unit 7 and a banknote storage unit 8 provided at an upper part and a lower part within a housing 1′. The deposit and dispensation handling unit 7 has a deposit accumulating portion 70 and a reject accumulating portion 71 that correspond to the front upper part of the housing 1′, and a dispensation accumulating portion 75 corresponding to the upper face part of the housing 1′. The deposit accumulating portion 70 and the reject accumulating portion 71 are openable to the outside via a shutter opening and closing type of banknote input portion 16 (see FIGS. 1 and 4). Moreover, the dispensation accumulating portion 75 is also openable to the outside via a shutter opening and closing type of loose banknote dispensation port 18 (see FIG. 4).

On the other hand, the banknote storage unit 8 includes one batch manner storage portion 8a and four banknote storage portions 8b-8e, which are arranged in line in the front-and-rear directions. The batch manner storage portion 8a is of an attachable and detachable cassette type, wherein the banknotes in mixed denominations are batch manner taken in from the upper part thereof and fed out from the upper part. The four banknote storage portions 8b-8e are stored with the loose banknotes according to the denominations of the banknotes. Upper edge parts of the batch manner storage portion 8a and of the banknote storage portions 8b-8e are provided with a temporary holding portion 84, and lower edge parts of the banknote storage portions 8b-8e are respectively provided with feeding members 86. Further, movable separators 80, 82 are provided by two stages in interiors of the storage portions 8a-8e.

The number of the banknote storage portions is, though herein exemplified by “4”, normally set equal to or larger the number of the denominations of the banknotes actually issued. For example, in the case of the U.S.A., there are seven denominations such as 1 dollar, 2 dollars, 5 dollars, 10 dollars, 50 dollars and 100 dollars. In the case of China, there are six denominations such as 1 yuan, 2 yuan, 5 yuan, 10 yuan, 50 yuan and 100 yuan. Hence, the banknote storage portions, of which the number is set equal to or larger than the number of these denominations, are provided.

The banknotes having large quantities of circulations can be smoothly arranged in their deposits and dispensations by increasing, if extremely different in terms of the quantities of circulations of those denominations, the number of the banknote storage portions for the banknotes having the large quantities of circulations. For example, in the case of U.S. dollar, if the 1-dollar banknotes have an overwhelming quantity of circulation, one more banknote storage portion is prepared for 1 dollar, and totally 8 pieces of banknote storage portions can be provided. Furthermore, conversely if the quantities of circulations of 50 dollars and 100 dollars are small, the banknotes of these denominations are stored in mixture, thus enabling the two storage portions to be ensured for the 1-dollar banknotes while keeping the seven storage portions unchanged. The number of the storage portions can be further reduced based on this idea.

The deposit accumulating portion 70 provided corresponding to the banknote input portion 16 is provided with a feeding member 72, and a deposit carrying path R1 is formed between the feeding member 72 and the temporary holding portion 84 for the storage portions 8a-8e. A deposit discriminating portion D1 and a front side and back side inverting portion 73 are provided midways of the deposit carrying path R1. Further, a dispensation carrying path R2 is formed between the feeding members 86 and the dispensation accumulating portion 75. A dispensation discriminating portion D2 is provided midways of the dispensation carrying path R2, and branches off to two stackers 76a, 76b and to a dispensation eject box 77 anterior to the dispensation accumulating portion 75. The deposit carrying path R1 also branches off to the reject accumulating portion 71 between the deposit discriminating portion D1 and the front side and back side inverting portion 73. Moreover, a bypass carrying path R3 branching off from the deposit carrying path R1 downstream of the front side and back side inverting portion 73 gets confluent with the dispensation carrying path R2 upstream of the stacker 76a.

In the rear of the stackers 76a, 76b, the bundle carrying unit 6 is enabled to enter. The pair of nipping portions 6a of the bundle carrying unit 6 is also movable up and down with respect to the moving portion 6b, corresponding to the two pieces of upper and lower stackers 76a, 76b. Further, as illustrated in FIG. 8, three lines of notched portions 70 corresponding to the three nipping pawls 60, 62, 64 are formed in each of the stackers 76a, 76b. The nipping pawls 60, 62, 64 of the pair of nipping portions 6a of the bundle carrying unit 6 nip the loose banknote bundle B′ (via the notched portions 70) accumulated in the stackers 76a, 76b, and can thus pull the banknote bundle B′ backward.

Herein, an operation of the loose banknote deposit and dispensation unit 103 will be briefly described.

Loose banknotes S inserted into the deposit accumulating portion 70 via the banknote input portion 16 are fed on a sheet-by-sheet basis by the feeding member 72 and are carried along the deposit carrying path R1. These loose banknotes S are discriminated between their denominations by the deposit discriminating portion D1, and undiscriminable deposit reject banknote's are returned to the reject accumulating portion 71. Further, the banknote S opposite in its front side and back side to the predetermined direction is inverted by the front side and back side inverting portion 73 and sent to the downstream side. The loose banknotes S sent via the deposit carrying path R1 to the storage unit 8 are stored in the storage portions 8b-8e corresponding to the denominations thereof or in the batch manner storage portion 8a. On this occasion, the loose banknotes S are, after being accumulated in the temporary holding portion 84, stored in the storage portions 8b-8e or in the batch manner storage portion 8a by dint of the operations of the movable separators 80, 82.

On the other hand, the loose banknotes S taken out of the upper part of the batch manner storage portion 8a are carried to the deposit discriminating portion D1. The loose banknotes S fed out on the sheet-by-sheet basis by the lower feeding members 86 from the storage portions 8b-8e are carried along the dispensation carrying path R2. These loose banknotes S are discriminated between their denominations by the dispensation discriminating portion D2. The dispensation reject banknotes undiscriminable to the discriminating portions D1, D2 are accumulated in the dispensation reject box 77. The loose banknotes S other than those undiscriminable banknotes are accumulated in the dispensation accumulating portion 75 or in any one of the stackers 76a, 76b in accordance with the purpose. The dispensation banknotes accumulated in the dispensation accumulating portion 75 are taken out via the loose banknote dispensation port 18. Further, the loose banknotes S inserted into the deposit accumulating portion 70 can be also accumulated directly in the stackers 76a, 76b without via the storage unit 8 by making use of the bypass carrying path R3.

### (3) New Banknote Dispensation Unit 105

The new banknote connotes an unused banknote or a banknote close to the unused banknote. The new banknote dispensation unit 105 is a single-function machine that simply pays out the new banknotes prepared beforehand in the cassette in response to a request because of high demands for the new banknotes. The new banknote dispensation unit 105 links up with neither the loose banknote deposit and dispensation unit 103 nor the bundle sorting dispensation unit 104.

As illustrated in FIG. 1, only a new dispensation port 90 is formed in the front panel of the housing.

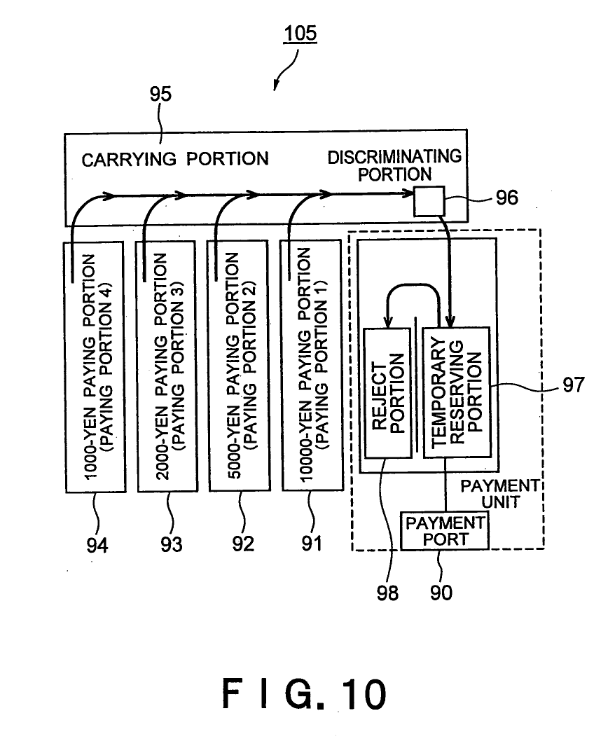

FIG. 10 is a schematic internal configuration diagram showing an internal configuration of the new banknote dispensation unit 105 and a flow of the banknotes.

Four cassette type dispensation units 91-94 previously stored with the new banknotes, wherein, for example, the first dispensation unit 91 is assigned to the banknotes of 10000 Yen, the second dispensation unit 92 is to the banknotes of 5000 Yen, the third dispensation unit 93 is to 2000 Yen, and the fourth dispensation unit 94 is to 1000 Yen.

Necessary sheets of banknotes are fed out of these dispensation units in response to an instruction, then carried by the carrying portion 95, and confirmed to be of the denomination instructed to be fed out but not to be the reject banknotes by a discriminating portion 96. All the carried banknotes, though reserved in the temporary holding portion 97, are paid out of the new banknote dispensation port if none of problems arise.

While on the other hand, if identified with the reject target banknotes, these banknotes reserved in the temporary holding portion are carried to the reject portion 98.

The types of the banknotes dealt with by the new banknote dispensation unit differ depending on the countries, and, as described above, the U.S.A. has the seven types of banknotes while China has the six types of banknotes. The types of the banknotes are, however, properly selected corresponding to the number of the dispensation units. The dispensation units can be assigned to the banknotes exhibiting a high frequency of usage and to the large denomination banknotes frequently used for special applications such as congratulations money. Further, as in the case of 1-dollar banknotes in the U.S.A. that has an overwhelmingly large quantity of circulation, a plurality of portions among the four dispensation units can be also assigned to 1-dollar banknotes.

The new banknote dispensation unit is neither indispensable for the system nor often installed as the case may be.

[Handling Contents]

Next, contents of a variety of processes by the banknote handling apparatus 100 according to the present embodiment will be explained in the way of roughly classifying the processes into the following processes (1)-(6). These processes are executed under control of a control unit of a computer etc on the basis of inputs etc from keyboards 113, 116 defined as operating units shown in FIG. 1, and the handling contents are displayed on display screens 111, 114 according to the necessity. Note that the descriptions of the respective processes will be made in a way that properly omits the explanations of the overlapped contents with those described earlier.

1. Process of Tying up Loose Banknotes into Banknote Bundle and Ejecting Banknote Bundle outside

1.1 Sorting Process

A sorting process is that the loose banknotes S (out-of-machine banknotes) inserted into the deposit accumulating portion 70 of the loose banknote deposit and dispensation unit 103 are sorted into the banknote bundles B (eject banknote bundles), which are ejected by the bundle sorting dispensation unit 104 from the bundle out-of-machine ejection port 13.

To be specific, at first, in the loose banknote deposit and dispensation unit 103 illustrated in FIG. 3, the loose banknotes S inserted into the deposit accumulating portion 70 are fed out on the sheet-by-sheet basis by the feeding member 72 and carried along the deposit carrying path R1. The loose banknotes S (excluding the banknotes returned to the reject accumulating portion 71) passing through the deposit discriminating portion D1 and the front side and back side inverting portion 73, are accumulated in the stackers 76a, 76b via the dispensation carrying path R2 from the bypass carrying path R3. The loose banknote bundles B′ accumulated in the stackers 76a, 76b are carried to the bundle sorting dispensation unit 104 by the carrying unit 6.

The loose banknote bundles B′ carried to the bundle sorting dispensation unit 104 illustrated in FIG. 4 are fed into the binding print unit 5 by the carrying unit 6. The fed-in loose banknote bundles B′ are tied up with the binding band W and fed as the banknote bundle B to the ascending and descending path 2 by the conveying belts 58, 59. In the meanwhile, the binding band W is printed with a predetermined print by the printer 5b and is stamped with a financial institution name stamp 5C and further stamped, if necessary, with an unfit banknote stamp 5d.

The banknote bundle B fed out to the ascending and descending path 2 is placed on the ascending and descending stage 20 standing by in a receiving position h1. In the case of taking the banknote bundle B out of the bundle dispensation port 10, after the stage 20 has descended to a dispensation position h2, a shutter of the bundle dispensation port 10 opens, whereby the banknote bundle B is taken out of the bundle dispensation port 10. Further, in the case of ejecting the banknote bundle B from the bundle out-of-machine ejection port 13, the stage 20 descends to a lower position h3, and, after a shutter of the bundle out-of-machine ejection port 13 has opened, the inclined plate 22 above the stage 20 gets tilted with the front being lowered, whereby the banknote bundle B is ejected from the bundle out-of-machine ejection port 13.

1.2 Bundle Collecting Process

A bundle collecting process is that the loose banknotes S (intra-machine banknotes) stored in the storage unit 8 of the loose banknote deposit and dispensation unit 103 are ejected from the bundle out-of-machine ejection port 13 in order to collect the banknotes S as the banknote bundle B (eject banknote bundle) in the bundle sorting dispensation unit 104. Specifically, to start with, in the loose banknote deposit and dispensation unit 103 shown in FIG. 9, the loose banknotes S stored in any one of the storage portions 8b-8e are fed out on the sheet-by-sheet basis by the feeding members 86 and carried along the dispensation carrying route R2. The loose banknotes S (excluding those sent to the dispensation reject box 77) passing through the dispensation discriminating portion D2 are accumulated in the stackers 76a, 76b. The loose banknote bundles B′ accumulated in the stackers 76a, 76b are carried to the bundle sorting dispensation unit 104 by the carrying unit 6.

Then, the loose banknote bundles B′ carried to the bundle sorting dispensation unit 104 illustrated in FIG. 5 are, in the same way as in the case of 1.1 Sorting Process, fed out as the banknote bundles B to the ascending and descending path 2 and ejected from the bundle out-of-machine ejection port 13.

Note that a variety of operations can be applied to this bundle collection, and, for example, in the case of targeting the bundle at only the banknotes of 100 yuan in China, it is feasible to collect fractions of the banknote of 100 yuan, which are, i.e., the banknotes of 50 yuan, 20 yuan and 10 yuan, in the batch manner storage portion and to collect the banknotes of the denominations designated by a customer in the way of carrying these banknotes to the loose banknote dispensation port 18.

1.3 Bundle Dispensation Process

A bundle dispensation process is a process of dispensing, as the banknote bundle B (ejection banknote bundle), the loose banknotes S (intra-machine banknotes) by the bundle sorting dispensation unit 104, which are stored in the banknote storage unit 8 of the loose banknote deposit and dispensation unit 103 and taking the banknote bundle B out of the bundle dispensation port 10.

To be specific, at first, in the loose banknote deposit and dispensation unit 103 illustrated in FIG. 9, in the same way as in the case of 1.2 Bundle Collecting Process, the loose banknotes S stored in any one of the storage portions 8b-8e are accumulated in the stackers 76a, 76b and carried as the loose banknote bundles B′ to the bundle sorting dispensation unit 104 by the carrying unit 6.

Then, the loose banknote bundles B′ carried to the bundle sorting dispensation unit 104 illustrated in FIG. 5 are, in the same way as in the case of 1.1 Sorting Process, fed out as the banknote bundles B to the ascending and descending path 2 and taken out of the bundle dispensation port 10.

2. Process of Tying up Loose Banknotes into Banknote Bundle and Storing Banknote Bundle

2.1 Bundle Loading Process

A bundle loading process is that the bundle sorting dispensation unit 104 stores the banknote bundle storage unit 3 with the loose banknotes S (out-of-machine banknotes), as the banknote bundle B (storage banknote bundle), inserted into the deposit accumulating portion 70 of the loose banknote deposit and dispensation unit 103.

Specifically, at the first onset, in the same way as in the case of 1.1 Sorting Process, the inserted loose banknotes S are tied up into the banknote bundle B. Namely, in the loose banknote deposit and dispensation unit 103, the loose banknotes S inserted into the deposit accumulating portion 70 are accumulated in the stackers 76a, 76b and carried as the loose banknote bundles B′ by the carrying unit 6 to the bundle sorting dispensation unit 104. Then, the loose banknote bundles B′ carried to the bundle sorting dispensation unit 104 shown in FIG. 5 are fed out as the banknote bundles B to the ascending and descending path 2 via the binding print unit 5.

The banknote bundles B fed out to the ascending and descending path 2 are, after being placed on the ascending and descending stage 20 standing by in the receiving position h1, lowered down to a height of the carrying path C. At this time, the opening and closing plates 34 for the ascending and descending path 2 are opened. Further, the swing retreat portion 4a of the carrying unit 4, which has retreated in preparation for the passage of the stage 20, swings to the carrying position and enters the ascending and descending path 2. Then, the banknote bundles B are carried along the carrying path C to the side of the banknote bundle storage unit 3 (the right side in FIG. 3) by driving the conveying belt 44 of the carrying unit 4. At this time, the bundle discriminating unit D discriminates between the denominations of the banknote bundles B.

When the banknote bundles B reach above the opening and closing plates 34 corresponding to the storage portions 3a-3e to which the banknote bundles B should be stored, the carrying belt 44 stops, then the opening and closing plates 34 open, and the banknote bundles B are stored in the storage portions 3a-3e. The specific storing operation is as described with reference to FIG. 5.

2.2 Intra-Machine Moving Loading and Auto Collecting Process

An intra-machine moving loading and auto collecting process is defined as an auto collecting function of, based on customer's setting, feeding the banknotes from the auto-designated banknote storage portion when the number of the banknotes accumulated in each of the respective storage portions 8b-8e becomes equal to or larger than a fixed accumulated banknote count, discriminating between the banknotes by the dispensation discriminating portion, tying up the banknotes into the bundles by the binding portion and storing the thus-obtained banknote bundles B in the banknote bundle storage portions, and also defined as an intra-machine moving loading function by which the customer himself or herself arbitrarily executes a process of tying up the banknotes in the banknote storage portions into the bundles by the bundle handling unit, corresponding to states of the respective storage portions and storing the banknote bundles in the banknote bundle storage unit 3.

Specifically, to begin with, in the loose banknote deposit and dispensation unit 103 illustrated in FIG. 9, the loose banknotes S in the storage portions 8b-8e, which have reached the banknote count designated by the customer, are, in the same way as in the case of 1.2 Bundle Collecting Process, accumulated in the stackers 76a, 76b and carried as the loose banknote bundles B′ by the carrying unit 6 to the bundle sorting dispensation unit 104.

Then, the loose banknote bundles B′ carried to the bundle sorting dispensation unit 104 shown in FIG. 5 are, in the same way as in the case of 2.1 Bundle Loading Process, fed out as the banknote bundles B to the ascending and descending path 2 and stored in the corresponding bundle storage portions 3a-3e.

Thus, it is possible not only to auto-collect the set number of banknotes in the storage unit but also to bundle the banknotes with the denomination designated corresponding to a state of the storage and store the banknote bundles in the bundle storage portion, wherein the handling itself is the same. In this case, the process is referred to as an intra-machine moving loading process, and a storage capacity of the storing unit can be ensured.

It is to be noted that if a plurality of temporary holding portions for bundling the banknotes is provided in the case of executing the process of tying up the loose banknotes in the process of tying up the first denomination of loose banknotes into the banknote bundles and ejecting these banknote bundles and in the process of tying up the second denomination of loose banknotes into the banknote bundles and storing these banknote bundles, the plurality of temporary holding portions is stored in distribution with both of the well-conditioned banknotes and the ill-conditioned banknotes on the basis of a discriminated result about the state of the banknotes by the discriminating portion, thereby enabling a distribution of the banknote states to be uniformized.

With this scheme, the banknote bundles containing only the well-conditioned banknotes or only the ill-conditioned banknotes can be prevented from being produced.

Moreover, the auto collecting function and the intra-machine moving loading function are carried out when reaching the customer's setting count in the description given above and may also be carried out when the respective storage portions get fully stored with the banknotes.

3. Process of Ejecting Stored Banknote Bundles Outside

3.1 Banknote Bundle Dispensation Process

A banknote bundle dispensation process is that the bundle sorting dispensation unit 104 pays the banknote bundles B (intra-machine banknote bundles) stored in the banknote bundle storage unit 3 and takes the banknote bundles B (as the eject banknote bundles) from the bundle dispensation port 10.

To be specific, the bundle sorting dispensation unit 104 illustrated in FIG. 5, at first, ejects the should-be-paid banknote bundles B to the carrying path C from the storage portions 3a-3e. A specific eject operation thereof is as described with reference to FIG. 7. The banknote bundles B ejected to the carrying path C are carried by the carrying unit 4 to the ascending and descending path 2 and placed on the ascending and descending stage 20 waiting there. Subsequently, the swing retreat portion 4a of the carrying unit 4 swings to the retreat position from the carrying position and thus retreats from within the ascending and descending path 2. Thereafter, the stage 20 rises to the dispensation position h2, and the shutter of the bundle dispensation port 10 opens, thereby taking the banknote bundles B out of the bundle dispensation port 10.

3.2 Banknote Bundle Out-of-Machine Ejection Port Collecting Process

A banknote bundle out-of-machine ejection port collecting process is a process sin which the bundle sorting dispensation unit 104 ejects the banknote bundles B (intra-machine banknote bundles) (as eject banknote bundles) stored in the banknote bundle storage unit 3 from the bundle out-of-machine ejection port 13 in order to collect the banknote bundles B.

Specifically, in the bundle sorting dispensation unit 104 shown in FIG. 5, to begin with, in the same way as in the case of 3.1 Banknote Bundle Dispensation Process, the should-be-collected banknote bundles B ejected from the storage portions 3a-3e are carried to the ascending and descending stage 20. Next, the stage 20 descends to a lower position h3, and, after the shutter of the bundle out-of-machine ejection port 13 has opened, the inclined plate 22 above the stage 20 gets tilted with the front being lowered, whereby the banknote bundle B is ejected from the bundle out-of-machine ejection port 13.

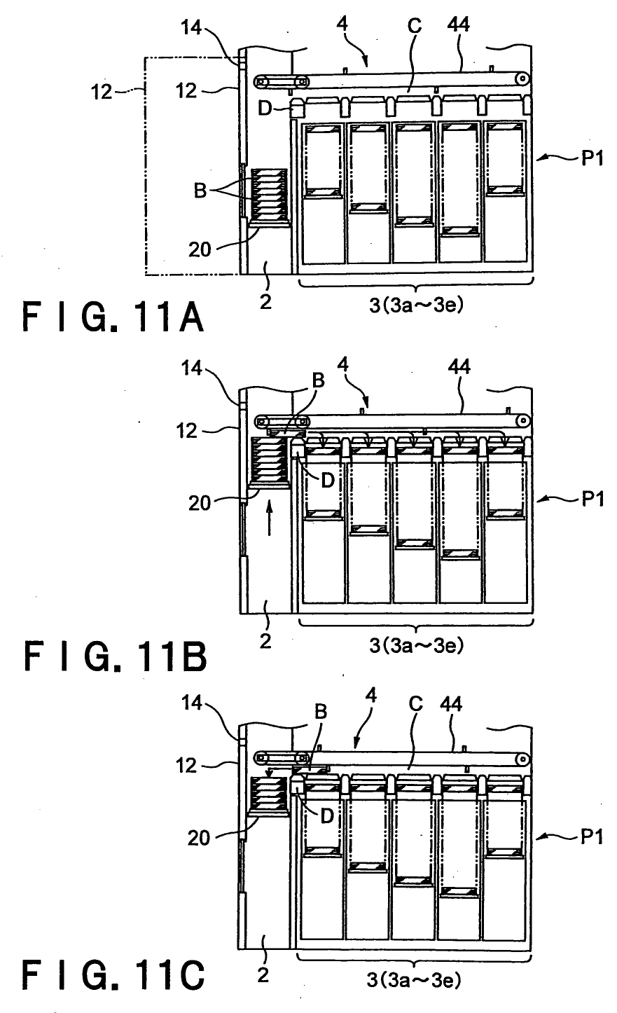

4. Out-of-Machine Bundle Loading Process (FIG. 11)

An out-of-machine bundle loading process is such a process that in the bundle sorting dispensation unit 104, the banknote bundles B (out-of-machine banknote bundles) inserted into the ascending and descending path 2 from the outside (via the opening and closing door 12) are automatically loaded (as storage banknote bundles) into the banknote bundle storage unit 3.

Specifically, when the operation unit 113 etc illustrated in FIG. 1 gives a predetermined loading instruction to the control unit, as shown in FIG. FIGS. 11A-11C, the process is executed in the following procedures. At first, the control unit automatically unlocks the locking device 14 of the opening and closing door 12 in the bundle sorting dispensation unit 104. The opening and closing door 12 opens, and, after the should-be-loaded banknote bundles B have been placed on the ascending and descending stage 20 waiting in the lower position h3 (FIG. 5) within the ascending and descending path 2, the opening and closing door 12 is closed (FIG. 11A).

Then, the control unit automatically locks the locking device 14 and starts auto-loading the inserted banknote bundles B (FIG. 11B). Namely, the stage 20 is raised on till the uppermost banknote bundle B reaches a height of the carrying path C, and this banknote bundle B is, in the same way as in the case of 2.1 Bundle Loading Process, loaded (stored) into the storage portions 3a-3e corresponding to the discriminated result of the bundle discriminating unit D. Thereafter, the respective banknote bundles B are similarly sequentially loaded while raising the stage 20 on a bundle-by-bundle basis.

In this case, the control unit sends the banknote bundles B undiscriminable to the bundle discriminating unit D when moved toward the storage unit 3 temporarily back toward the ascending and descending path 2 and then returns these banknote bundles B toward the storage unit 3 by use of the carrying unit 4, and, on this occasion, the banknote bundles B are again discriminated by the bundle discriminating unit D. This re-discriminating process may be done plural number of times according to the necessity.

Note that if the banknote bundles B moved by the carrying unit 4 toward the storage unit 3 are those disabled to be loaded into the storage unit 3, the control unit executes the following process. At the first onset, the carrying unit 4 returns the banknote bundles B onto the stage 20 of the ascending and descending path 2 (FIG. 11C). Then, a prompt of removing the banknote bundles B is displayed on the display screen 105a etc illustrated in FIG. 1.

This removal prompt display includes a display item enabled to specify a reason why the banknote bundles B can not be loaded into the storage unit 3. This reason is, it is considered, exemplified such as a reason (a) that the banknote bundles B are undiscriminable, a reason (b) that the bundle storage portions 3a-3e corresponding to the denomination of the banknote bundles B are already full of the banknote bundles, and a reason (c) that the bundle storage portions 3a-3e include none of setting of the storage portion corresponding to the denomination of the banknote bundles B.

These reasons are displayed in sentences or code numbers or symbols associated with these respective reasons on the display device.

The banknote bundles B can be automatically loaded into the storage unit 3 from outside by enabling the out-of-machine loading process to be executed. It is therefore possible to perform loading more accurately in a shorter period of time than in the case of manually loading the banknote bundles B. Further, the opening and closing door 12 can be automatically locked and unlocked by the locking device 14 when loading the banknote bundles B, and hence inconvenience caused when using a key can be obviated. Moreover, the stricter loading process can be executed by loading the banknote bundles B while the bundle discriminating unit D conducts the discriminating process. Further, the undiscriminable banknote bundles B are re-discriminated, thereby enabling a possibility of interrupting the auto loading process to be reduced by decreasing the number (occurrence frequency) of the banknote bundles B becoming undiscriminable to the end.

Moreover, in this out-of-machine loading process, if the banknote bundles B moved toward the storage unit 3 are those disabled to be loaded into the storage unit 3, the banknote bundles B are returned onto the stage 20 of the ascending and descending path 2, and the prompt for removing the banknote bundles B is displayed, thereby enabling the banknote bundles B to be immediately removed and the operation to be quickly get ready for resuming the loading process. On this occasion, the removal prompt display includes the display item enabled to specify the reason why the banknote bundles B can not be loaded into the storage unit 3, thereby making it possible to take a measure for preventing reoccurrence due to the same reason.

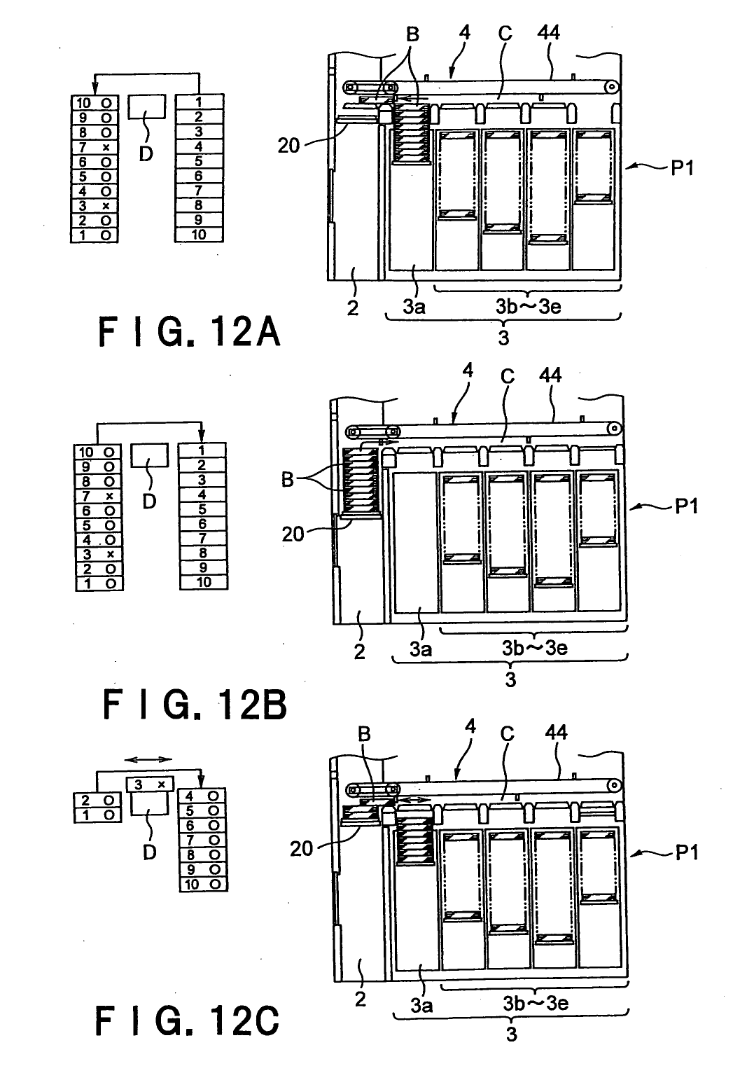

5. Auto Careful Inspection Process (FIG. 12)

An auto careful examination process is a process in which the bundle sorting dispensation unit 104 automatically carefully inspects the banknote bundles B (intra-machine banknote bundles) (an amount of balance is established by verifying the denominations, the number of banknote bundles, etc.) stored in the banknote bundle storage unit 3.

Specifically, when the operation unit 113 etc illustrated in FIG. 1 gives an instruction for a predetermined careful inspection to the control unit, as shown in FIGS. 12A-12C, the control unit executes a process in the following procedures. To begin with, the banknote bundles B are ejected bundle by bundle from the target bundle storage portion (which is herein the bundle storage portion 3a according to the denomination), then carried toward the ascending and descending path 2 and accumulated onto the ascending and descending stage 20. At this time, the bundle discriminating unit D performs the first discriminating process about each of the banknote bundles B (FIG. 12A).

Next, the banknote bundles B accumulated onto the stage 20 are returned to the previous bundle storage portion 3a, and in the meantime the bundle discriminating unit D conducts the second discriminating process about only the banknote bundles B that have proven undiscriminable in the first discriminating process (FIG. 12B). In the illustrative example, the second discriminating process is carried out about only the third and seventh banknote bundles B with a mark (x) representing being undiscriminable in the first discriminating process, among the first through tenth banknote bundles B.

At this time, the banknote bundle B (which is the third banknote bundle in the illustrative example) proving undiscriminable even in the second discriminating process is temporarily carried back toward the ascending and descending path 2 by the carrying unit 4 and then returned toward the storage unit 3, and in the meantime the bundle discriminating unit D performs the third discriminating process (FIG. 12C). If disabled to be discriminated in the third discriminating process, this leads to a prompt of taking action through an alarm on a display screen 111 or 114 illustrated in FIG. 11 or both of these screens. Note that the third and fourth discriminating processes can be also executed when the banknote bundle B reciprocates.

In the auto careful inspection process, the banknote bundles B are, after being moved to the ascending and descending path 2 from the storage unit 3, returned to the storage unit 3 from the ascending and descending path 2, and in the meantime the careful inspection process is executed about the banknote bundle B on the basis of the discriminated result by the bundle discriminating unit D. Hence, the auto careful inspection process can be done without emptying any one of the bundle storage portions 3a-3e. It is therefore feasible to reduce the time required for the auto careful inspection process by highly efficiently performing the careful inspection process.

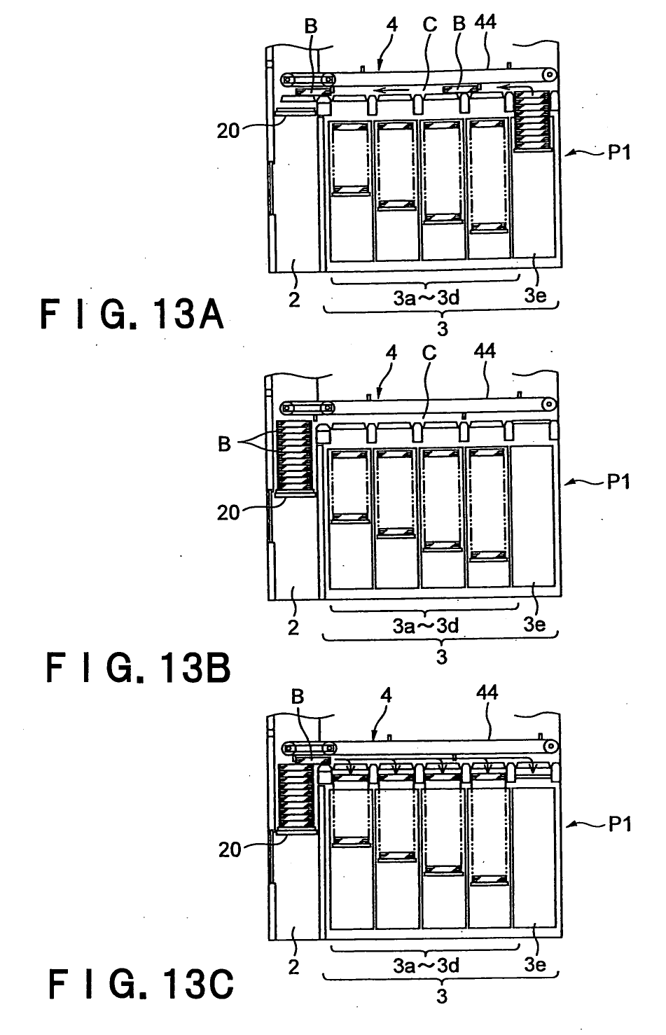

6. Auto Allocating Process (FIG. 13)

An auto allocating process is that the banknote bundles B stored in the denomination-mixed state in the batch manner storage portion 3e of the banknote bundle storage unit 3 of the bundle sorting dispensation unit 104, are automatically allocated to the bundle storage portions 3a-3e according to the corresponding denominations by use of the ascending and descending path 2.

To be specific, when the operation unit 113 etc illustrated in FIG. 1 gives a predetermined allocating instruction to the control unit, as shown in FIGS. 13A-13C, the control unit executes a process in the following procedures. At first, the banknote bundles B are ejected bundle by bundle from the batch manner storage portion 3e then carried toward the ascending and descending path 2 (FIG. 13A), and accumulated onto the ascending and descending stage 20 (FIG. 13B). After finishing moving all the banknote bundles B to the ascending and descending path 2, these banknote bundles B are returned on the bundle-by-bundle basis to the storage unit 3 and stored in the bundle storage portions 3a-3e according to the denominations corresponding to the discriminated results by the bundle discriminating unit D.

Note that this process may involve conducting the discriminating processes up to the third time similarly to the case of 5. Auto Careful Inspection Process, however, the discriminating process corresponding to second or third time among these processes may also be omitted.

In the auto careful inspection process, the banknote bundles B stored in the batch manner storage portion 3e are, after being moved to the ascending and descending path 2, allocated to the bundle storage portions 3a-3d according to the denominations from the ascending and descending path 2. Hence, the banknote bundles B to be allocated are, if corresponding to the already-fully-stored bundle storage portions 3a-3d according to the denominations or even if corresponding to none of the bundle storage portions 3a-3d according to the denominations, returned again to the batch manner storage portion 3e, whereby the allocating process can continue. Therefore, the process of allocating the banknote bundles to the bundle storage portions 3a-3d according to the denominations from the batch manner storage portion 3e can be smoothly executed.

Further, in (5) Auto Careful Inspection Process and (6) Auto allocating Process, the discriminating process up to the second time is executed during one reciprocation of the banknote bundles B between the storage unit 3 and the ascending and descending path 2, thereby enabling the auto careful inspection process and the auto allocating process to be executed at the higher efficiency. Moreover, the number (occurrence frequency) of the banknote bundles B becoming undiscriminable to the end can be reduced by further performing the third discriminating process according to the necessity.

B. Coin Handling Unit

As described above, the coin machine for depositing, dispensing, and sorting that executes the coin-oriented process is, as illustrated in FIG. 1, constructed of the loose coin deposit and dispensation unit 102 and the packaged coin dispensation unit 101.

An upper part of the loose coin deposit and dispensation unit 102 is formed with a coin input portion 121. Normally, a shutter of the coin input portion 121 remains closed but gets opened when inserting the loose coins, and the hopper 201 gets exposed. A right lower side of the coin input portion 121 is formed with a reject port 122 into which the coins rejected when deposited are returned. Further, a calculation chute 123 into which the counted coins are ejected is formed at a central part of the front panel. The calculation chute 123 is used for an in-bag process of simply counting the coins and putting the coins into a bag. Moreover, a return box 124 receiving the loose coins to be returned is installed on the left side of the front panel.

On the other hand, the packaged coin dispensation unit 101 is provided at its upper part with a wrapped coin dispensation port 125. Provided at a middle stage thereof are a wrapped coin batch manner storage box 127 for storing batch manner the wrapped coins disabled to be stored in the storage portions according to the denominations and a loose coin dispensation box 129 for dispensing the loose coins. A wrapped coin ejection port 126 from which to eject the wrapped coins when in the collecting process is formed in a lower part of the front panel. An out-of-machine fraction box 128 into which the coins rejected when wrapped are thrown, is provide at the lower end part at the center.

The respective units will hereinafter be described.

(1) Loose Coin Deposit and Dispensation Unit 102

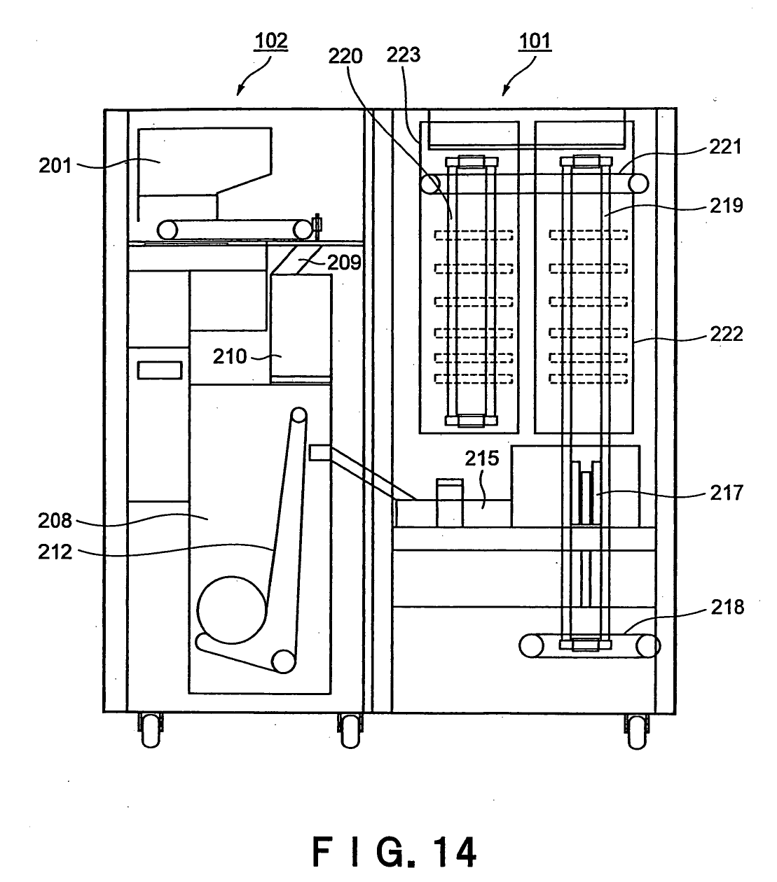

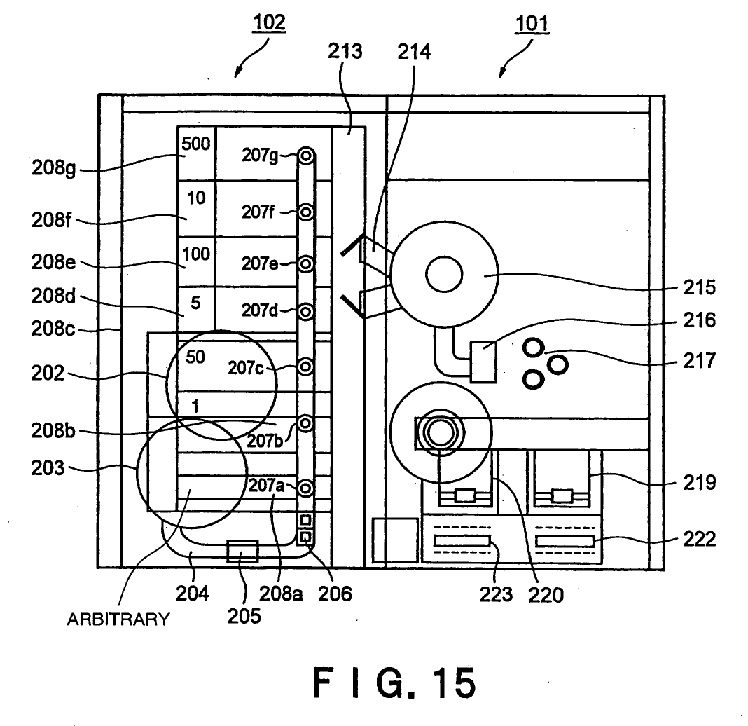

FIG. 14 is a vertical sectional view schematically illustrating an internal structure of the coin handling unit in FIG. 1. FIG. 15 is a plan view schematically showing a main configuration in FIG. 14.

The coins put into the coin input hopper 201 are sent one by one to a path 204 by a supply disc 202 existing on a bottom face of the hopper 201 and by a rotary disc 203 supplied with the coins by predetermined quantities through rotations of the supply disc 202.

The path 204 is provided with a discriminating portion 205 that specifies the type of the coin from a material, a size and a pattern on the surface. Provided in the path 204 ahead of the discriminating portion 205 are a reject selecting portion 206 for rejecting contaminated and unfit coins etc, and denomination selecting portions 207a through 207g that drop down the coins coming under the denominations concerned on the basis of diameters of apertures thereof. The coins passing through the denomination selecting portions 207a-207g are accumulated in temporary holding portions 210 provided for the respective denomination selecting portions via a chute 209 serving as a guide member. Bottoms of the temporary holding portions 210 are opened, whereby the coins are stored in coin storage portions 208a-208g. Herein, the symbol ‘a’ represents the arbitrary denomination selecting portion (and the arbitrary coin storage portion), while the symbols ‘b’ through ‘g’ represent the denomination selecting portions and the coin storage portions, which are provided, in the case of the coins circulated in Japan, in the sequence from the smallest diameter such as 1 yen, 50 yen, 5 yen, 100 yen, 10 yen and 500 yen. As for the arbitrary selecting portion (and the arbitrary coin storage portion), it is possible to set the overflow coins, the direct-wrapping-oriented coins and the bag-input-oriented coins of the denominations, which can not be stored in the temporary holding portions and the coin storage feeding portions.

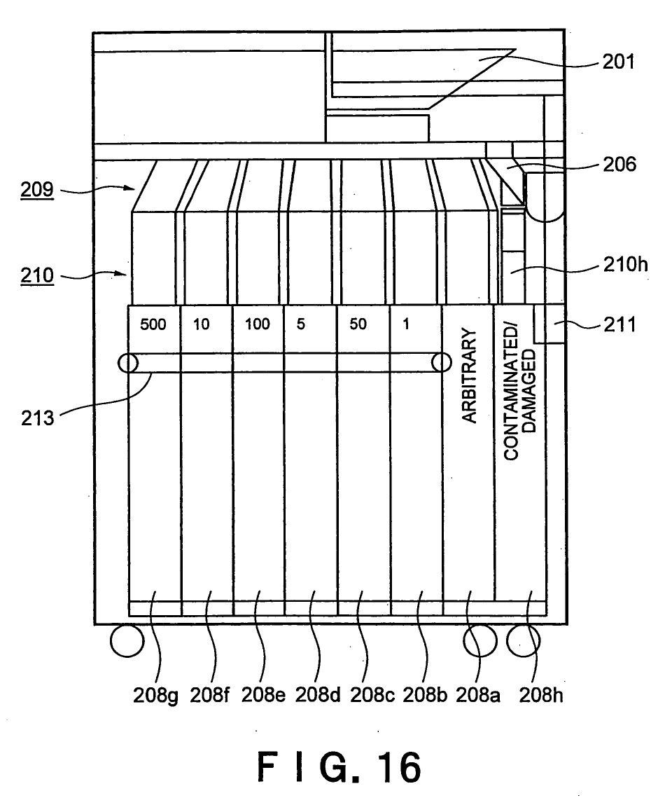

FIG. 16 is a side view showing a layout of these coin storage portions. As apparent from FIG. 16, a reject storage portion 208h is provided for the contaminated and unfit coins as well. It is to be noted that the coins rejected by the reject selecting portion 206 can be output into the reject port 122 by switching over the route.

The coins stored in the respective coin storage portions 208 are taken out by a takeout mechanism 212 using the belt shown in FIG. 13, and are placed on a belt carrying path 213 movable in forward and backward directions.

(2) Wrapped coin Dispensation Unit 101

The coins on the belt carrying path 213 of the loose coin deposit and dispensation unit 102 are guided onto a rotary disc 215 for wrapping the coins by a take-in mechanism 214 having two guides and then accumulated in an accumulating portion 216 through rotations of the rotary disc 215. After a predetermined number of coins have been accumulated in the accumulating portion 216, the coins are wrapped by a coin wrapping portion 217. The coin wrapping portion 217 is, as known well, constructed such that a predetermined number of stacked coins are pushed up to a predetermined wrapping position by a support rod protruding upward and rotated by three pieces of wrapping rollers while nipping peripheral surfaces of the stacked coins, then a sheet of wrapping paper (not illustrated) is wound around peripheries of the stacked coins by wrapping the wrapping paper along the peripheral surfaces of the stacked coins, and the edge of the wrapping paper is caulked to the edge surfaces of the stacked coins, thus obtaining the wrapped coins (a bar of coins).

The wrapped coins are carried by a belt carrying mechanism 218 to a first elevator 219. The first elevator 219 rises to carry the wrapped coins, hereby the wrapped coins are stored in a proper storage portion of first wrapped coin storage portions 222 provided upward. Second wrapped coin storage portions 223 are provided in parallel with the first wrapped coin storage portions 222. Similarly, a second elevator 220 is provided for moving the wrapped coins up and down. Further, a belt carrying mechanism 221 is provided for moving the wrapped coins in the horizontal direction between the first elevator 219 and the second elevator 220, thereby increasing a storage capacity with a narrow space. Moreover, the wrapped coins are controlled to be stored alternately in the wrapped coin storage portions 222, 223 by use of the belt carrying mechanism 221 or stored in the wrapped coin storage portions having a less storage quantity, thus enabling the wrapped coins to be stored evenly in distribution.

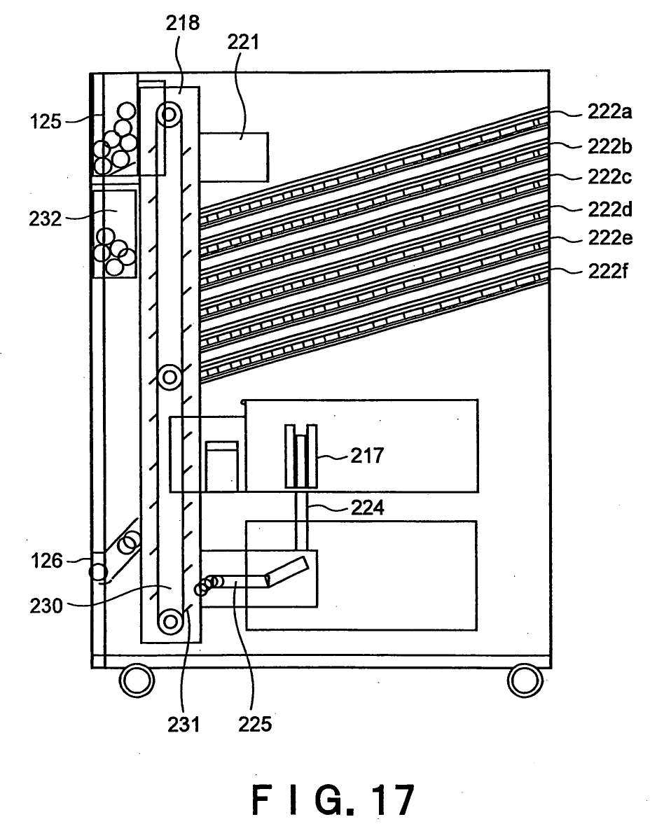

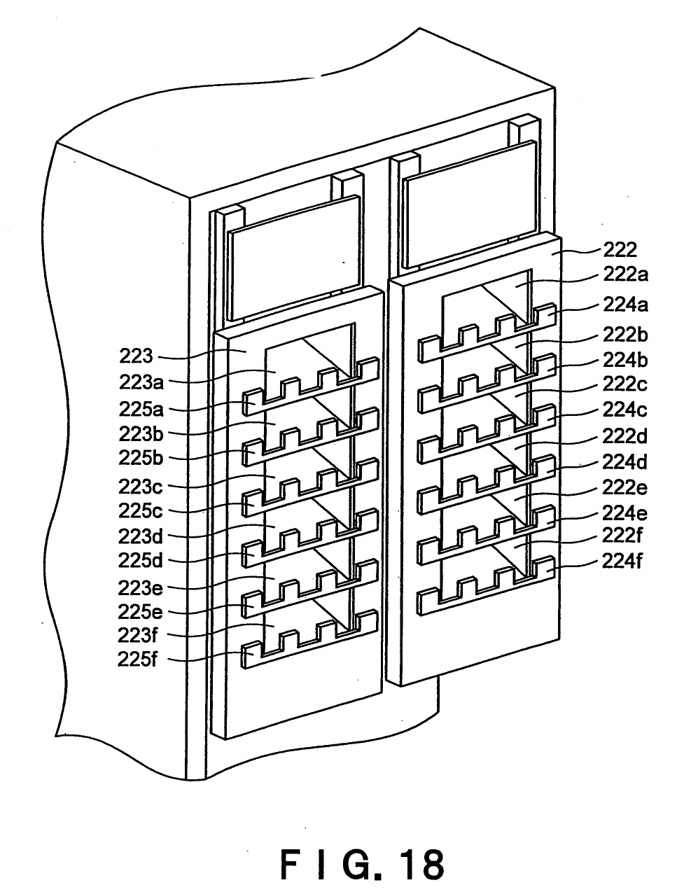

FIG. 17 is a side view of the main configuration related to storing the wrapped coins, as viewed from a right side surface in FIG. 14. FIG. 18 is a perspective view showing one example of the wrapped coin storage portions 222, 223. Herein, each of the wrapped coin storage portions 222, 223 has six sections (bar-of-wrapped coins trays) attached with suffixes ‘a’-‘f’.

As described above, the coins are wrapped by the coin wrapping portion 217, however, the post-wrapping coins are set vertical in a longitudinal direction, i.e., in a stacking direction and therefore hard to deal with. Hence, the wrapped coins are dropped by use of the first chute 224, at which time the longitudinal direction of the wrapped coins is invariably parallel with the front surface of the main body, and the second chute 225 is formed so that the wrapped coins get rolling to the front of the elevator while changing the longitudinal direction to the horizontal direction.

A belt 230 partly constituting the elevator 218 is driven by a motor (not illustrated) and stretched between upper and lower rotatable pulleys. Fins 231 having an angle directed upward and building up a placing portion are embedded at fixed intervals in the surface of the belt 230. The wrapped coins are mounted one by one on the fins and raised while being driven by the elevator.

The wrapped coin storage portions 222, 223 provided at the upper part include storage-oriented inclined plates 222a-222f, 223a-223f installed at substantially the same angle as that of each fin 231. Stopper plates 224a-224f, 225a-225f having notched portions are provided on the inlet side thereof. For moving the wrapped coins to the inclined plates 222a-222f from the fins 231 of the elevator, the wrapped coins may be moved onto the inclined plates over the stopper plates from the fin portion by use of a take-in and take-out member having such a shape as to enable its front end to pass through the notched portion.

Note that the wrapped coins are moved onto the fins of the elevator by slightly raising the take-in and take-out member inserted into the notched portion when taking the wrapped coins out of the wrapped coin storage portion as when outputting the wrapped coins. Then, the wrapped coins get gravity-dropped when passing by the maximum point, and hence the wrapped coin dispensation port 125 (see FIG. 16) is provided at this position. It is therefore possible to take the wrapped coins from the wrapped coin dispensation port 125.

Moreover, a vertically-movable box 232 into which the wrapped coins are put, whereby the wrapped coins to be output can be stored therein. This output box can be cassettized, and can be also exchanged by opening the front door and taking out the box as the necessity may arise. Further, an output port 126 (see FIG. 1) via which to output the wrapped coins outside the machine on a single coin-bar basis according to the necessity, is provided at the lower part of the front panel.

Next, handling contents, based on the configurations described above, in the coin handling units 103, 104 according to the present embodiment will be explained with reference to FIGS. 14-18. These processes are executed based on the inputs from the operation unit 113 illustrated in FIG. 1 under the control of the control unit, and the handling contents are displayed on the display screen 111 as the necessity may arise.

7. Process Related to Input of Loose Coins into Loose Coin Input Port

7.1 Loose Coin Deposit Process

When setting the loose coins into the hopper 201 shown in FIG. 14 by opening the shutter 121 shown in FIG. 1, the coins are sent as the supply disc 202 rotates and fed out one by one to the coin path 204 and then carried along this coin path. The discriminating portion 205 provided midways of the coin path 204 discriminates between the coins about the fit and unfit states, the denominations, etc. The reject selecting portion 206 for rejecting the contaminated and unfit coins etc rejects the contaminated and unfit coins, and the rejected coins are, after being temporarily reserved in a temporary holding portion 210h, discharged from the reject port 122. In this case, such a scheme can be also set that the coins are accumulated in a coin storage portion 208h under the temporary holding portion 210h by switching over the route. Moreover, the fit (normal) coins passing through the denomination selecting portions 207a-207g are accumulated in the temporary holding portions 210 provided for the respective denomination selecting portions via the chute 209 serving as the guide member. The coins are, when the bottoms of these temporary holding portions are opened, stored in the coin storage portions 208a-208g.

7.2 Loose Coin Loading Process

A loose coin loading process, which is similar to 7.1 Loose Coin Deposit Process, is that the fit (normal) coins are likewise stored in the coin storage portions via the denomination selecting portions. If judged to be the unfit coins by the reject selecting portion 206, however, the unfit coins are discharged directly into the reject port 122 without via the temporary holding portion 210h by switching over the chute direction.

7.3 Coin Wrapping Loading Process

A coin wrapping loading process is, similarly to 7.1 Loose Coin Deposit Process, that the loose coins set in the hopper 201 are taken in, then discriminated by the coin discriminating portion 205 and placed on the belt carrying path 213 movable in the forward and backward directions. The coins on the belt carrying path 213 are guided by the take-in mechanism 214 having the two guides onto the rotary disc 215 for wrapping the coins. With the rotations of the rotary disc 215, the coins are accumulated in the accumulating portion 216. A predetermined number of coins are, after being accumulated in the accumulating portion 216, wrapped by use of the three wrapping rollers in the coin wrapping portion 217. Then, the wrapped coins are sent to the first elevator 219 by the belt carrying mechanism 218. The wrapped coins are raised and thus carried by the first elevator 219 and are, just over the maximum point, stored in the wrapped coin batch manner storage box 232.

7.4 Sorting Process

In 7.1 Loose Coin Deposit Process, the coins placed on the belt carrying path 213 movable in the forward and backward directions are guided onto the rotary disc 215 for wrapping the coins by the take-in mechanism 214 having the two guides and accumulated in the accumulating unit 216 through the rotations of the rotary disc 215. The predetermined number of coins are, after being accumulated in the accumulating unit 216, wrapped by use of the three wrapping rollers in the coin wrapping portion 217.

The wrapped coins are sent to the first elevator 219 by the belt carrying mechanism 218. Then, the wrapped coins are raised and thus carried by the first elevator 219 and are, just over the maximum point, discharged to the wrapped coin dispensation port 126, thus enabling the wrapped coins to be taken out.

7.5 In-Bag Process

An in-bag process is, similarly to 7.1 Loose Coin Deposit Process, that the loose coins set in the hopper 201 are taken in, then counted and output from a calculation chute 123 provided at the central part of the front panel. This process intends to verify the number of coins already proven to be the fit (normal) coins, however, the discriminating process is conducted for eliminating the contaminated and unfit coins. The contamination and unfitetection can involve setting [ON] and [OFF]. In the case of setting [ON], based on the discriminated result, the contaminated and unfit coins are rejected, while the fit coins (normal coins) are put in a storage bag set in the calculation chute 123, whereby the in-bag coins convenient for portability within the financial institution can be obtained (the in-bag process can be executed).

On the other hand, in the case setting [OFF], both of the fit coins and the contaminated and unfit coins are taken as the in-bag coins by setting the storage bags in the calculation chute 123.

8. Process Related to Feed-Out from Loose Coin Storage Portion

8.1 Loose Coin Dispensation Process

When the control unit gives a loose coin dispensing instruction, a necessary number of coins of the designated denomination, which are stored in the coin storage portions 208a-208g, are taken out by the takeout mechanism 212, and discharged to the loose coin dispensation box 129 illustrated in FIG. 1 via the carrying path (not illustrated), carrying box, etc, and the desired coins are thus obtained from the loose coin dispensation box 129.

8.2 Loose Coin Auto Collecting Process and Intra-Machine Moving Loading Process

A loose coin auto collecting process is a process executed when any one of the coin storage portions 208a-208g reaches the coin count set by the customer and when a residual quantity in the wrapped coin storage portion becomes small. The loose coin auto collecting process is a process of feeding the loose coins from the coin storage portion, then wrapping the loose coins by the coin wrapping portion 217, carrying the wrapped coins by use of the elevator 219 etc, and storing the wrapped coins in an output-oriented cassette 222. The cassette 222 is taken out by pulling out the front panel of a wrapped coin processor 102.

This process can be performed, without being limited to when reaching the coin count set by the customer, similarly based on the instruction. In this case, the coins are simply moved within the machine, which is therefore referred to as an intra-machine moving loading process.

Moreover, the auto collection can be also conducted when the coin storage portions get full of the coins irrespective of the setting.

8.3 Loose-Coin Pack Collecting Process

A loose coin pack collecting process is the same as 8.2 Loose Coin Auto Collecting Process and Intra-Machine Moving Loading Process in terms of such a point that the loose coins are fed out of any designated storage portion among the coin storage portions 208a-208g, then wrapped by the coin wrapping portion 217, and the wrapped coins are carried by use of the elevator 219 etc. The loose coin pack collecting process is, however, different from 8.2 Process in terms of a point that the wrapped coins are ejected from the wrapped coin ejection port 126 via an out-of-machine chute.

8.4 Loose Coin Denomination-Based Storage Portion Collecting Process

A loose coin denomination-based storage portion collecting process is a process, wherein the loose coins are fed out of the coin storage portion of the designated denomination among the coin storage portions 208a-208g and discharge into the dispensation reject box.

9. Process Related to Feed-Out from Wrapped Coin Batch Manner Storage Box

9.1 Wrapped Coin Dispensation Process

A wrapped coin dispensation process is a process of feeding out a designated number of wrapped coins of a designated denomination from the wrapped coin storage portions 222, 223 and discharging the wrapped coins into the wrapped coin dispensation port 125.

9.2 Wrapped Coin Ejection Port Collecting Process

A wrapped coin ejection port collecting process is a process of feeding out a designated number of wrapped coins of a designated denomination from the wrapped coin storage portions 222, 223 and ejecting the wrapped coins outside the machine from the wrapped coin ejection port 126.

9.3 Wrapped coin Dispensation Port Collecting Process

A wrapped coin dispensation port collecting process is a process of feeding out a designated number of wrapped coins of a designated denomination from the wrapped coin storage portions 222, 223 and discharging the wrapped coins into the wrapped coin dispensation port 125.

In addition to the processes described above, the banknote and coin handling system according to the present invention enables the manual direct takeout. Namely, the necessary doors are formed to enable the batch manner takeout from the batch manner storage portion, the batch manner takeout from the bundled banknote cassette, the batch manner takeout from the wrapped coin batch manner storage box and also the single takeout of the wrapped coins.

The embodiment discussed above has exemplified nothing but one example of each of the configurations of the respective portions, and the scope of the present invention embraces changes, modifications, replacements with substituting units, and enlargement or contraction, which are carried out in the range of normal knowledge of those skilled in the art.

For example, normally the coin storage portions are provided by the number corresponding to the number of types of the circulated coins, however, this scheme is not necessarily attained. Namely, if a sufficient number of coin storage portions can not be provided in terms of the size, a configuration is that the coins may be stored in the mixed state of the denominations and may be selected according to the denominations when dispensing and wrapping the coins. Moreover, the two or more coin storage portions can be allocated to the coins of which the usage frequency is high.

As for the processes about the coins described above, the storage portions can be provided corresponding to the denominations of the coins circulating in the respective countries, e.g., the six existing denominations such as 1 dollar, 50 cents, 25 cents, 10 cents, 5 cents and 1 cent in the U.S.A. and the six existing denominations such as 1 yuan, 5 jao, 1 jao, 5 fen, 2 fen and 1 fen in China. As a matter of fact, however, the three denominations of 5 fen, 2 fen and 1 fen each have a small quantity of circulation in China, and hence these currencies may not wrapped according to the denominations but may be received in a loose state.

The banknote and coin handling system described above is one example, and, the banknote and coin handling system according to the present invention may be any type of system if having the configuration of combining together the apparatus dealing with the banknotes and the apparatus dealing with the coins. For example, the right-and-left positions of the loose coin deposit and dispensation unit 102 and the wrapped coin dispensation unit 101 may be reversed.

Further, the banknote and coin handling system described above has, basically, the combination of the four units such as the loose banknote deposit and dispensation unit and the bundle sorting dispensation unit that execute the process related to the banknotes, and the loose coin deposit and dispensation unit and the wrapped coin dispensation unit that execute the process related to the coins. A banknote machine for depositing, dispensing, and sorting having the same function related to the banknotes may be combined with a coin machine for depositing, dispensing, and sorting, or apparatuses having further sub-functions may also be combined.

### (Fund Management System)

A fund management system of the present invention will now be described.

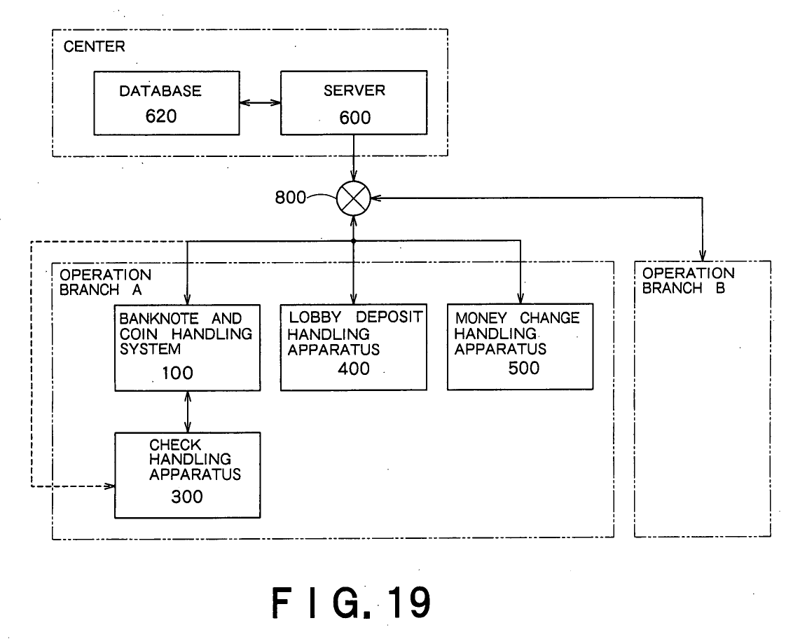

First, a configuration of the fund management system of the present invention will be described with reference to FIG. 19. FIG. 19 is a block diagram showing a configuration of the fund management system according to the present invention.

As shown in FIG. 19, the fund management system includes a banknote and coin handling system 100, a check handling apparatus 300, a lobby deposit handling apparatus 400, a money change handling apparatus 500 that are installed at an operation branch, and a server 600 and a database 620 installed at a center. The server 600 is connected to the banknote and coin handling system 100, the lobby deposit handling apparatus 400, and the money change handling apparatus 500 installed at each operation branch, through a network 800. The check handling apparatus 300 of each operation branch is connected to the banknote and coin handling system 100. The check handling apparatus 300 of each operation branch may be connected to the server 600 through the network 800.

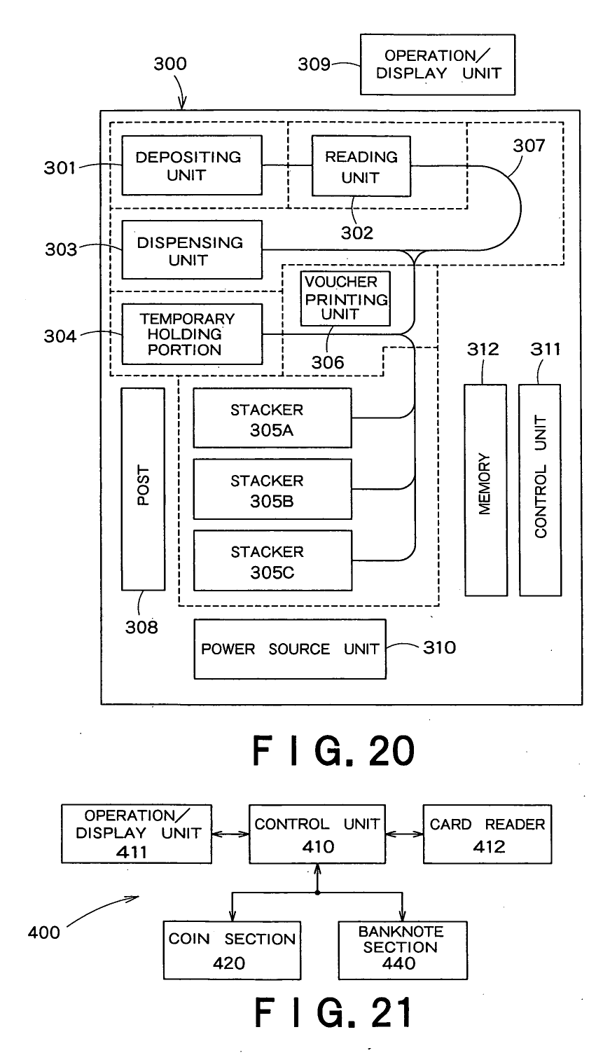

Next, a configuration of the check handling apparatus 300 installed at each operation branch will be described with reference to FIG. 20. FIG. 20 is a vertical sectional view showing an internal structure of the check handling apparatus 300 illustrated in FIG. 19.

As shown in FIG. 20, the check handling apparatus 300 includes a depositing unit 301 that accepts a check into the machine, a reading unit 302 that reads image information of the check, a dispensing unit 303 that dispenses the check, a temporary holding unit 304 that temporarily reserves the check, a storage unit provided with stackers 305A to 305C that store the checks by type, a voucher printing unit 306 that prints voucher information, a transport unit 307 that transports the check, a post 308 that stores a medium that cannot be stored in the stackers 305A to 305C, an operation/display unit 309 that accepts a command of a user and that displays predetermined information, a power source unit 310 that supplies power, a control unit 311 that controls each component and that communicates with the banknote and coin handling system 100 or the server 600 shown in FIG. 19, and a memory 312 that stores various data including check data (total amount of money and/or total number of checks of each stacker 305A to 305C, total amount of money and/or total number of checks of all stackers 305A to 305C, amount of money and/or number of checks of each check, image information of each check, character information of each check, total amount of money and/or total number of checks of the post 308, etc.).

Functions of the check handling apparatus 300 will now be described.

A deposit function includes a function of accepting a check set in the depositing unit 301 into the machine, a function of reading image information of the check, and a function of discriminating type, amount of money, etc. of the check from character information or the like. The deposit function also includes a consecutively accepting mode for consecutively accepting the checks set in the depositing unit 301 into the machine and a one sheet accepting mode that accepts the checks set in the depositing unit 301 into the machine on a one-by-one basis.

A temporary holding function is a function of temporarily reserving a check in the temporary holding unit 304 and feeding out the check from the temporary holding unit 304 after the confirmation of the deposit. The deposit confirmation is made when the user presses a confirmation key of an operation unit 113 of the banknote and coin handling system 100.

A storage function is a function of storing the checks fed out from the temporary holding unit 304 in the stackers 305A to 305C by type. When a check is deposited, the check is stored according to the discriminated type if the reading unit 302 can discriminate the type, and the check is stored according to the type inputted by the user from the operation/display unit 309 if the reading unit 302 cannot discriminate the type.

A dispense function is a function of dispensing a check passing through the reading unit 302, a check fed out from the temporary holding unit 304, or a check that cannot be read out by the reading unit 302, out of the machine.

A selection function is a function of accepting a user command related to a selection of the type of check or a selection of a transport mode set from terminal units 111 and 114 or from the operation/display unit 309 to the depositing unit 301. The transport mode is determined by a combination of an accepting method (one sheet acceptance/consecutive acceptance), a transporting method (store/dispense), and a printing method (exist/does not exist).

An endorse function includes a function of printing the serial number, the date, etc. of the deposited check and a function of changing the timing of printing and the existence of printing.

A collection function is a function in which the person in charge of collection operates the operation/display unit 309, selects the stackers 305A to 305C to be collected, collects the checks stored in the selected stackers 305A to 305C, and clears the check data stored in the memory 312.

A post storage function is a function of storing a medium that cannot be stored in the stackers 305A to 305C into a post 308.

An electronic filing function includes a function of writing the image information of the check and the character information identified from the image information into the memory 312, a function of encrypting the image information stored in the memory 312, a function of copying the image information stored in the memory 312 to an attachable and detachable storage medium (for example, MO disk), a function of searching the image information stored in the memory 312 in accordance with a search command by the user accepted by the operation/display unit 309 and displaying the search result on the operation/display unit 309, and a function of printing the image information stored in the memory 312.

An image entry function is a function of displaying the image information stored in the memory 312 on the operation/display unit 309. In the image entry function, the user can operate-the operation/display unit 309 while watching the image information displayed on the operation/display unit 309 to input new or adjusted information of the check (amount of money, clearinghouse number, financial institution, branch office, date of issue, check number, etc.) that the reading unit 302 cannot discriminate the type or has erroneously read out.

A count/record output function includes a function of counting the check data stored in the memory 312 for each predetermined condition and a function of outputting the count result to a record.

A data communication function is a function of transmitting the check data stored in the memory 312 to the banknote and coin handling system 100 or the server 600.

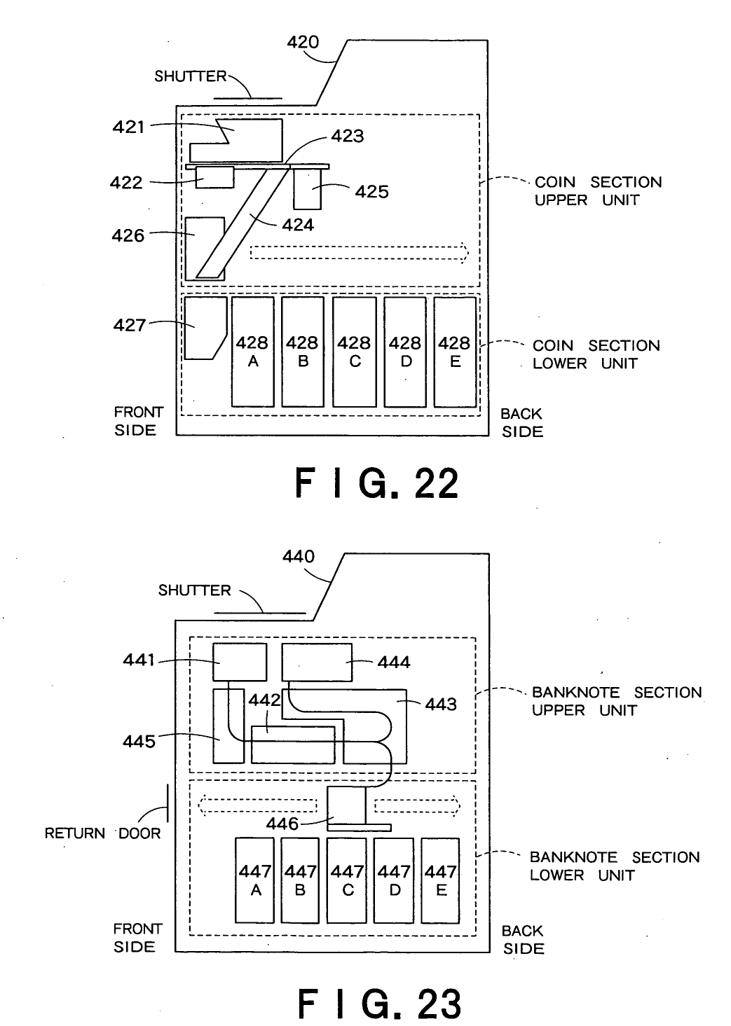

Next, a configuration of the lobby deposit handling apparatus 400 installed at each operation branch will be described with reference to FIGS. 21 to 23. FIG. 21 is a block diagram showing a configuration of the lobby deposit handling apparatus 400 illustrated in FIG. 19. FIG. 22 is a vertical sectional view schematically showing an internal structure of a coin section 420 illustrated in FIG. 21. FIG. 23 is a vertical sectional view schematically showing an internal structure of a banknote section 440 illustrated in FIG. 21.

As shown in FIG. 21, the lobby deposit handling apparatus 400 includes a control unit 410, an operation/display unit 411 that accepts a command of the user and that displays predetermined information, a card reader 412 that reads an ID card, the coin section 420 that executes a deposit process of coins, and the banknote section 440 that executes a deposit process of banknotes. The control unit 410 is configured to control the operation/display unit 411, the card reader 412, the coin section 420, and the banknote section 440 and to communication with the server 600 shown in FIG. 19.

As shown in FIG. 22, a coin section upper unit includes a depositing unit 421 that accepts the coins deposited by the user into the machine, a discriminating unit 422 that discriminates the denomination or the authenticity of the coins, a carrying path 423 that carries the coins, a reject chute 424 that drops the rejected coins that cannot be discriminated by the discriminating unit 422 to a return/reject unit 427, a temporary holding chute 425 that drops the normal coins discriminated by the discriminating unit 422 to a temporary holding unit 426, and the temporary holding unit 426 that is slidable in the arrow direction and that temporarily reserves the normal coins dropped from the temporary holding chute 425.

As shown in FIG. 22, a coin section lower unit includes the return/reject unit 427 that stores the coins dropped from the reject chute 424 and cassettes 428A to 428E that store the coins temporarily reserved in the temporary holding unit 426 in a multi-denomination state. The number of the cassettes 428 can be changed.

As shown in FIG. 23, the banknote section 440 includes a banknote section upper unit and a banknote section lower unit. The banknote section 440 includes a shutter of an inlet arranged on the upper surface and a return door arranged on the front side.

As shown in FIG. 23, the banknote section upper unit includes a depositing unit 441 that accepts the banknotes deposited by the user into the machine, a discriminating unit 442 that discriminates the denomination or the authenticity of the banknotes, a diverting unit 443 that diverts the normal banknotes discriminated by the discriminating unit 442 to a temporary holding unit 446 and that diverts the rejected banknotes which cannot be discriminated by the discriminating unit 442 to a reject unit 444, the reject unit 444 that stacks the rejected banknotes, and a carrying path 445 that carries the banknotes.

As shown in FIG. 23, the banknote section lower unit is slidable in the arrow direction of FIG. 23 and includes the temporary holding unit 446 that temporarily reserves the normal banknotes and cassettes 447A to 447E that store the banknotes in a multi-denomination state. The number of the cassettes 447 can be changed.

Functions of the lobby deposit handling apparatus 400 will now be described.

A deposit function includes a loose coin deposit function for depositing loose coins and a loose banknote deposit function for depositing loose banknotes.

In the loose coin deposit function, the coins inserted into the depositing unit 421 is discriminated and counted, the coins are temporarily reserved in the temporary holding unit 426, the coins temporarily reserved in the temporary holding unit 426 is fed out after the confirmation of the deposit, and the coins are stored in the cassettes 428A to 428E in a multi-denomination state. Furthermore, the coins temporarily reserved in the temporary holding unit 426 is returned to the customer from the return/reject unit 427 upon cancellation or error, and the event occurred when the coins are returned is printed or recorded in a log. In addition, the rejected coins that cannot be discriminated by the discriminating unit 422 are stored in the return/reject unit 427 and returned to the customer.

In the loose banknote deposit function, the banknotes set in the depositing unit 441 are discriminated and counted, the banknotes are temporarily reserved in the temporary holding unit 446, the banknotes temporarily reserved in the temporary holding unit 446 are fed out after the confirmation of the deposit, and the banknotes are stored in the cassettes 447A to 447E in a multi-denomination state. Furthermore, the banknotes temporarily reserved in the temporary holding unit 446 are returned to the customer from the reject unit 444 upon cancellation or error, and the event occurred when the banknotes are returned is printed or recorded in a log. In addition, the rejected banknotes, such as banknotes that cannot be discriminated by the discriminating unit 442 and stained banknotes, are stacked in the reject unit 444 and returned to the customer.

When the loose coin deposit function or the loose banknote deposit function is executed, the lobby deposit handling apparatus 400 can read the ID card or the like in which the user is registered in advance, identify the user, open the shutter of the inlet when the identification is successful, and switch to an insert standby state.

An operation/display function is a function of displaying predetermined information and accepting a command of the customer through a touch-panel type user interface or a push-button type hard key.

A print function includes a function of discharging an acceptance receipt printed with acceptance number and customer name after the deposit is finished, a function of discharging the acceptance receipt from the printer installed in the teller, and a function of issuing an alert when the acceptance receipt is not picked up within a predetermined time. In the actual operation, the customer picks up the discharged acceptance receipt and hands over the acceptance receipt and the passbook to a bank employee. The bank employee compares the acceptance number printed on the acceptance receipt discharged from the printer installed in the teller and the acceptance number printed on the acceptance receipt received from the customer and, if they match, performs online processing and writes down in the passbook. The acceptance receipt may be discharged from a printer installed in the lobby deposit handling apparatus 400 or may be discharged from a printer connected to the lobby deposit handling apparatus 400.

A management function of total amount of money and/or total number of banknotes and coins of the lobby deposit handling apparatus 400 includes a function of storing the total amount of money and/or total number of banknotes and coins on a denomination-by-denomination basis and a function of displaying the total amount of money and/or total number of banknotes and coins.

A data clear function includes a function of clearing the total amount of money and/or total number of banknotes and coins on a device-by-device basis or cassette-by-cassette basis upon collection, a function of clearing the transaction data and the data of the total amount of money and/or total number of banknotes and coins, and a function of selecting the overnight carry-over or zero clear of the data of the total amount of money and/or total number of banknotes and coins.

A unit selection function is a function of selecting whether to use the coin section 420 or the banknote section 440.

A timer setting function is a function of setting weekly or daily power source or setting the station opening/closing time.

An journal data function includes a function of recording the log of the journal contents and a function of searching the transactions, denomination, or total amount of money included in the journal data.

A state detection function is a function of detecting a full state, a near-full state, and a near-end state of the total amount of money and/or total number of banknotes and coins as well as the out-of-paper of the receipt paper or the journal paper.

A remote monitoring function includes a function of displaying the total amount of money and/or total number of banknotes and coins, state, and handling contents during the deposit in real time on the server 600 connected to the lobby deposit handling apparatus 400, a function of issuing an alert upon error, and a function of switching ON/OFF of the power source or cancellation of use.

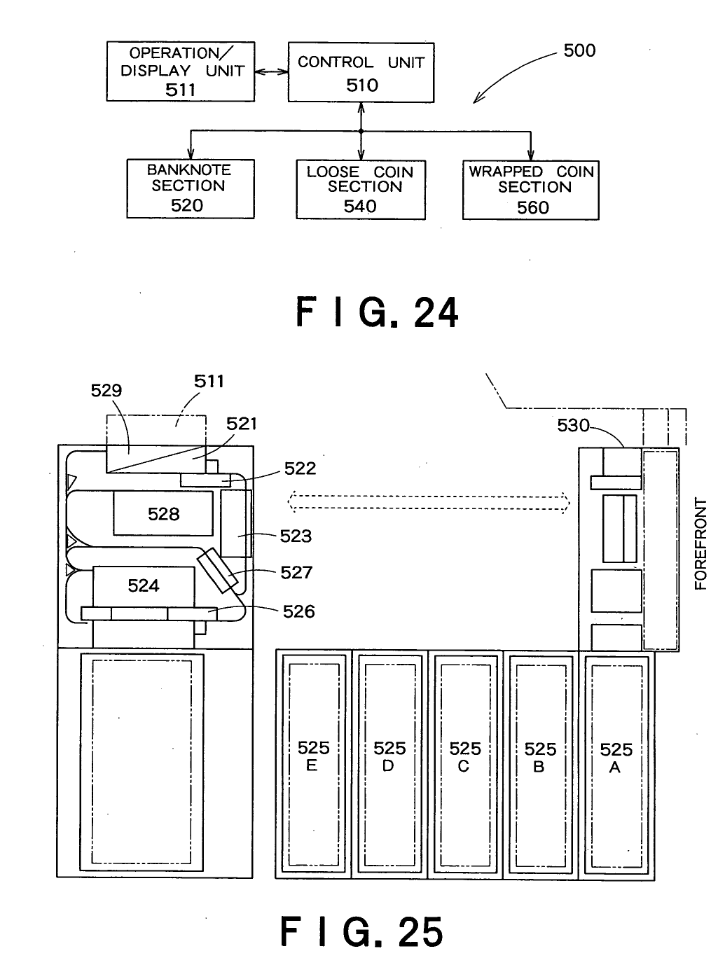

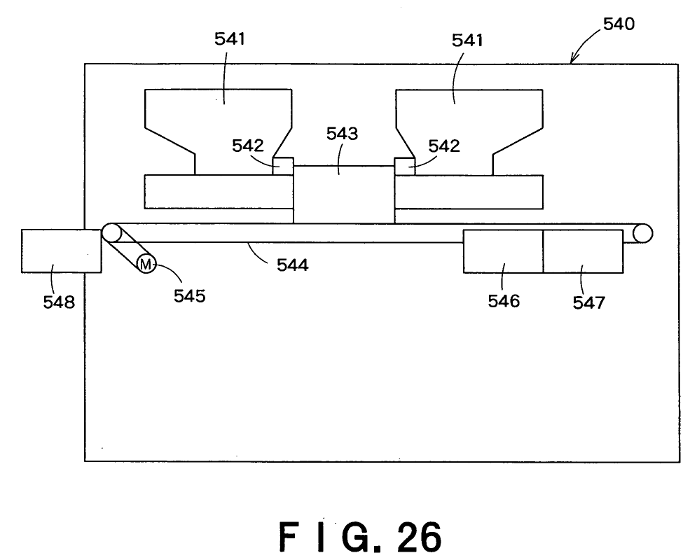

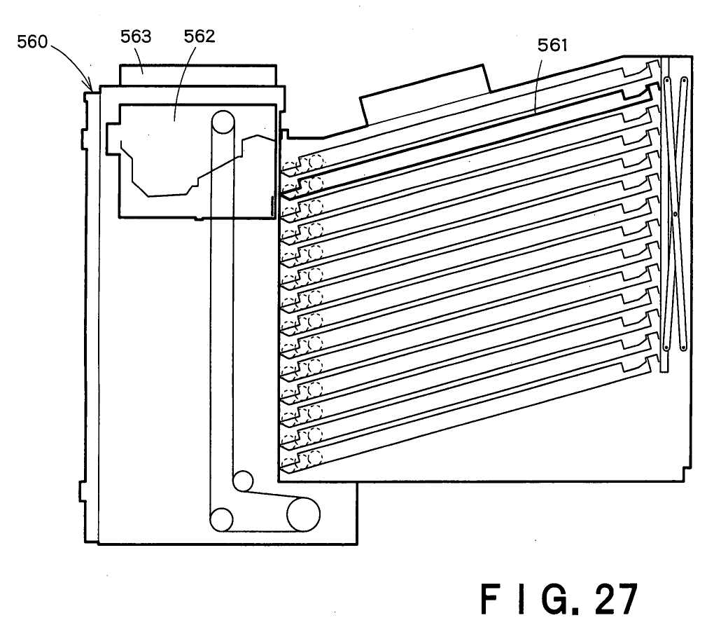

Next, a configuration of the money change handling apparatus 500 installed at each operation branch will be described with reference to FIGS. 24 to 27. FIG. 24 is a block diagram showing a configuration of the money change handling apparatus 500 illustrated in FIG. 19. FIG. 25 is a vertical sectional view schematically showing an internal structure of a banknote section 520 illustrated in FIG. 24. FIG. 26 is a vertical sectional view schematically showing an internal structure of a loose coin section 540 illustrated in FIG. 24. FIG. 27 is a vertical sectional view schematically showing an internal structure of a wrapped coin section 560 illustrated in FIG. 24.

As shown in FIG. 24, the money change handling apparatus 500 includes a control unit 510, an operation/display unit 511 that accepts a command of the user and that displays predetermined information, the banknote section 520 that executes a money changing process of the banknotes, the loose coin section 540 that executes a money changing process of the loose coins, and the wrapped coin section 560 that executes a money changing process of the wrapped coins. The control unit 510 is configured to control the operation/display unit 511, the banknote section 520, the loose coin section 540, and the wrapped coin section 560 and communicate with the server 600 shown in FIG. 19.

As shown in FIG. 25, the banknote section 520 includes a deposit feeding unit 522 that feeds out the banknotes set in an inlet 521 into the machine, a deposit discriminating unit 523 that discriminates the banknotes fed out by the deposit feeding unit 522, a deposit temporary holding unit 524 that temporarily reserves the banknotes discriminated by the deposit discriminating unit 523, cassettes 525A to 525E that stores the banknotes temporarily reserved in the deposit temporary holding unit 524 on a denomination-by-denomination basis, a dispensation feeding unit 526 that feeds out the banknotes stored in the cassettes 525A to 525E, a dispensation discriminating unit 527 that discriminates the banknotes fed out by the dispensation feeding unit 526, a dispensation reject unit 528 that stores the dispensation rejected banknotes that cannot be discriminated by the dispensation discriminating unit 527, a return port/outlet 529 that returns the deposit rejected banknotes that cannot be discriminated by the deposit discriminating unit 523 to the customer and that dispenses the banknotes discriminated by the dispensation discriminating unit 527, and a transport unit 530 that is slidable in the arrow direction of FIG. 23. The number of the cassettes 525 can be changed, and the denomination stored in the cassettes 525A to 525E can also be changed.

As shown in FIG. 26, the loose coin section 540 includes a denomination coin storage unit 541 that stores the coins on a denomination-by-denomination basis, a discriminating unit 542 that discriminates and counts the coins, a temporary holding unit 543 that temporarily reserves the coins, a transport unit 544 that transports the coins, a motor 545 that drives the transport unit 544, a collecting unit 546 that collects the coins, a reject unit 547 that stores the rejected coins, and an outlet 548 that dispenses the loose coins.

The denomination coin storage unit 541 is configured to store the coins replenished by the administrator of the loose coin section 540 on a denomination-by-denomination basis. The administrator replenishes the coins on a denomination-by-denomination basis.

The loose coin section 540 may also include a loose coin deposit unit (not shown). The loose coin deposit unit accepts coins from the customer to execute a money changing process from coin to coin or to collect a fee of the money changing process. The loose coin deposit unit includes a coin inlet for the customer to insert coins, a discriminating unit that discriminates the coins inserted in the coin inlet, a storage unit that stores the discriminated coins, and a reject unit that returns the coins other than the accepted coins inserted into the coin inlet or the canceled coins to the customer. The loose coin deposit unit also includes a function of printing or recording the event occurred when the coins are transported to the reject unit.

As shown in FIG. 27, the wrapped coin section 560 includes trays 561 that store the wrapped coins on a denomination-by-denomination basis, an elevator 562 that is slidable and that transports the wrapped coins stored in the trays 561 to an outlet 563, and the outlet 563 that dispenses the wrapped coins transported by the elevator 562.

Functions of the money change handling apparatus 500 will now be described.

A deposit function includes a loose coin deposit function for depositing loose coins and a loose banknote deposit function for depositing loose banknotes.

The loose coin deposit function is a function realized when the loose coin section 540 includes a loose coin deposit unit. In the loose coin deposit function, the coins inserted into the coin inlet of the loose coin deposit unit by the customer is discriminated and counted, and the coins are stored in a storage unit. Furthermore, when unacceptable coins are inserted into the coin inlet, the coins are returned to the customer from the reject unit of the loose coin deposit unit. In addition, the inserted coins are returned to the customer from the reject unit of the loose coin deposit unit upon cancellation or error, and the event occurred when the coins are returned is printed or recorded in a log. Furthermore, the rejected coins that cannot be discriminated by the discriminating unit of the loose coin deposit unit are returned to the customer from the reject unit.

In the loose banknote deposit function, the banknotes set to the inlet 521 are discriminated and counted, the banknotes are temporarily reserved in the temporary holding unit 524, the banknotes temporarily reserved in the temporary holding unit 524 are fed out after the confirmation of the deposit, and the banknotes are stored in the cassettes 525A to 525E. In case of cancellation or error while the banknotes are temporarily reserved by the temporary holding unit 524, the banknotes temporarily reserved in the temporary holding unit 524 are returned to the customer from the return port/outlet 529, and the event occurred when the banknotes are returned is printed or recorded in a log. Furthermore, the rejected banknotes, such as banknotes that cannot be discriminated by the deposit discriminating unit 523 and stained banknotes, or foreign materials are returned to the customer from the return port/outlet 529.

A money change selection function includes a function of accepting a selection of the money change denomination and the number of wrapped coins and a function of displaying the type of exchangeable currencies (loose banknotes, loose coins, and wrapped coins) and the money change contents (money change denomination, the number of wrapped coins, and amount of money). The money change handling apparatus 500 is configured to execute a dispensation function when the user confirms the displayed money change contents and presses the confirmation button.

The dispensation function includes a loose coin dispensation function for dispensing loose coins, a loose banknote dispensation function for dispensing loose banknotes, a wrapped coin dispensation function for dispensing wrapped coins, a function of opening the shutters of the return port/outlet 529 and the outlet 548 in a predetermined order, a function of closing the shutters after the coins and the banknotes dispensed to the return port/outlet 529 and the outlet 548 are removed, and a function of setting the order of closing the shutters.

In the loose coin dispensation function, the loose coins stored in the loose coin storage unit 541 are fed out, the fed out loose coins are discriminated, the discriminated loose coins are temporarily reserved in the temporary holding unit 543, the coins temporarily reserved in the temporary holding unit 543 are fed out after the number of coins requested by the customer on a denomination-by-denomination basis are gathered, and the coins are dispensed from the outlet 548. Furthermore, coins in which abnormalities are detected (for example, coins of denomination not requested by the customer or medium-abnormal coins) are stored in the reject unit 547.

In the loose banknote dispensation function, the banknotes stored in the cassettes 525A to 525E are fed out, the fed out banknotes are discriminated, and the discriminated banknotes are dispensed from the return port/outlet 529. Furthermore, banknotes in which abnormalities are detected (for example, banknotes of denomination not requested by the customer or medium-abnormal banknotes) are stored in the dispensation reject unit 528.

In the wrapped coin dispensation function, the wrapped coins stored in the trays 561 are fed out, and the fed out coins are dispensed from the outlet 563.

An operation/display function is a function of displaying predetermined information and accepting a command of the customer through a touch-panel type user interface or a push-button type hard key.

A management function of total amount of money and/or total number of banknotes and coins of the money change handling apparatus 500 includes a function of storing the total amount of money and/or total number of banknotes and coins on a denomination-by-de nomination basis, a function of displaying the total amount of money and/or total number of banknotes and coins, a function of accepting an input of an amount of fund loaded in the banknote section 520, the loose coin section 540, and the wrapped coin section 560, and a function of accepting a selection of the cassettes 525A to 525E, the collecting unit 546, and the trays 561 to be collected.

A loose coin collection function is a function of collecting the loose coins to the collecting unit 546 while counting the loose coins.

A wrapped coin reconciliation function is a function of counting the number of wrapped coins stored in the trays 561 and matching the number with the total amount of money and/or total number of coins of the wrapped coins.

A data clear function includes a function of clearing the total amount of money and/or total number of banknotes and coins on a device-by-device, cassette-by-cassette, or tray-by-tray basis upon collection, a function of clearing the transaction data and the data of the total amount of money and/or total number of banknotes and coins, and a function of selecting the overnight carry-over or clear of the data of the total amount of money and/or total number of banknotes and coins.

A human detection function is a function of automatically opening the shutter of the inlet 521 when a human detection sensor detects a human.

A remote monitoring function includes a function of displaying the total amount of money and/or total number of banknotes and coins, state, and handling contents during money change in real time on a remote monitor (not shown) connected to the money change handling apparatus 500, a function of issuing an alert when an error has occurred, and a function of switching ON/OFF of the power source and withdrawal.

A wrapped coin setting function is a function of setting the denomination stored in each tray 561 of the wrapped coin section 560.

A fee collection function is a function of displaying and collecting the fees according to the conditions such as denomination, amount, and number of times of the money changing process. The fees are collected by a method of using a dedicated fee collecting unit or by direct debit, and in either case, a meter rate system (collecting fees calculated according to the amount of dispensation) or a fixed rate system (collecting a fixed amount of fees regardless of the number of uses) is employed.

A money change denomination pattern registration function includes a function of registering money change denomination patterns (combination of loose banknotes, loose coins, and wrapped coins) user by user and a function of accepting a selection of the registered money change denomination patterns.

A unit selection function is a function of selecting whether to use the loose banknote section 520, the loose coin section 540, or the wrapped coin section 560.

A journal data function includes a function of recording a log of the journal contents and a function of searching a transaction, denomination, total amount of money, etc., included in the journal data.

A state detection function is a function of detecting a full state, a near-full state, and a near-end state of the total amount of money and/or total number of banknotes and coins, and the out-of-paper of the receipt paper or the journal paper.

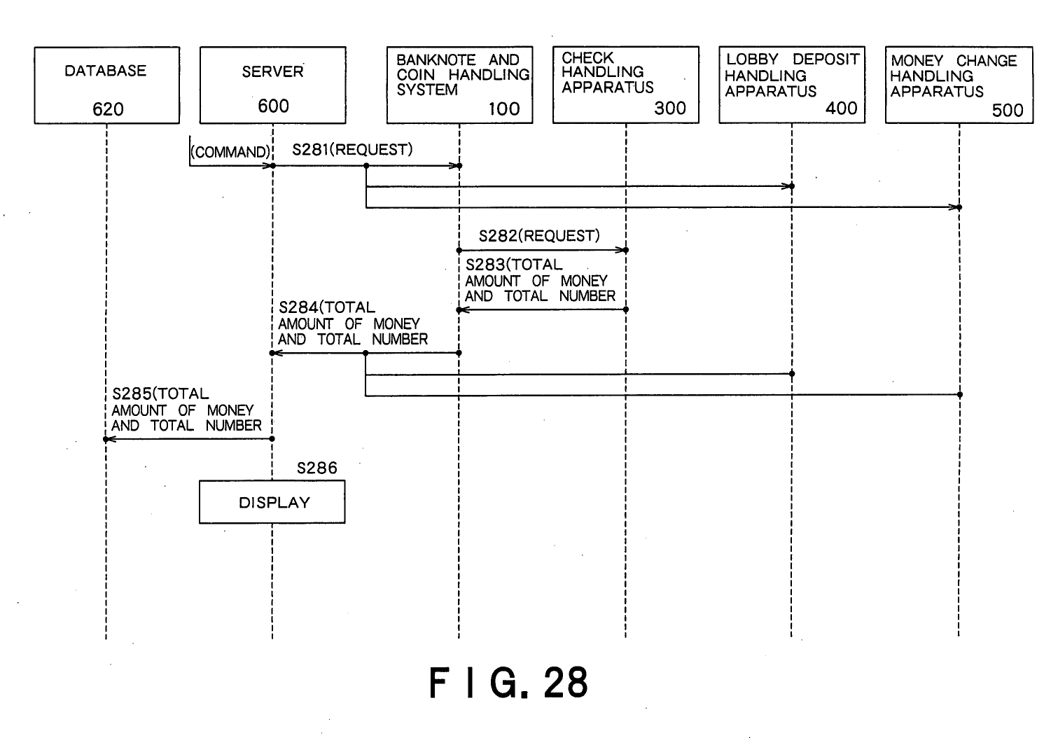

A management function of the total amount of money and/or total number of banknotes, coins, and checks of the fund management system will now be described with reference to FIG. 28. FIG. 28 is a sequence diagram showing an outline of the management function of the total amount of money and/or total number of banknotes, coins, and checks of the fund management system.

As shown in FIG. 28, when the user issues a command of inquiry of the total amount of money and/or total number of banknotes, coins, and checks to the server 600, the server 600 transmits a request of the total amount of money and/or total number of banknotes, coins, and checks to the banknote and coin handling system 100,.the lobby deposit handling apparatus 400, and the money change handling apparatus 500 installed at each operation branch (S281). The command of inquiry of the total amount of money and/or total number of banknotes, coins, and checks includes classification (all branches, districts, operation branches, equipment (banknote and coin handling system 100, check handling apparatus 300, lobby deposit handling apparatus 400, and money change handling apparatus 500), denomination, and types (machine balance, balance on hand, inventory balance, and post balance)), date, and equipment. The machine balance is total amount of money and/or total number of banknotes, coins, and checks of the coin handling system 100, the check handling apparatus 300, the lobby deposit handling apparatus 400, and the money change handling apparatus 500. The balance on hand is total amount of money and/or total number of banknotes, coins, and checks that is not stored in any of the check handling apparatus 300, the lobby deposit handling apparatus 400, and the money change handling apparatus 500 managed by the banknote and coin handling system 100. The inventory balance is amount of cash and/or total number of banknotes, coins, and checks in a large safe (not shown). The post balance is total amount of money and/or total number of checks of the post 308.

As shown in FIG. 28, the banknote and coin handling system 100 transmits the request of the total amount of money and/or total number of checks to the check handling apparatus 300 (S282). In response, the check handling apparatus 300 transmits the total amount of money and/or total number of checks of the check handling apparatus 300 to the banknote and coin handling system 100 (S283).

As shown in FIG. 28, each of the banknote and coin handling system 100, the lobby deposit handling apparatus 400, and the money change handling apparatus 500 transmits the total amount of money and/or total number of banknotes, coins, and checks to the server 600 (S284). In this case, the banknote and coin handling system 100 transmits the total amount of money and/or total number of checks of the check handling apparatus 300 in addition to the total amount of money and/or total number of banknotes and coins of the banknote and coin handling system 100.

As shown in FIG. 28, the server 600 registers the total amount of money and/or total number of banknotes, coins, and checks transmitted from the banknote and coin handling system 100, the lobby deposit handling apparatus 400, and the money change handling apparatus 500 to the database 620 (S285).

As shown in FIG. 28, the server 600 displays the total amount of money and/or total number of banknotes, coins, and checks of the banknote and coin handling system 100, the check handling apparatus 300, the lobby deposit handling apparatus 400, and the money change handling apparatus 500 in accordance with the command of inquiry of the total amount of money and/or total number of banknotes, coins, and checks of S281 (S286). For example, the server 600 may display, in a list or in a graph, the total amount of money and/or total number of banknotes, coins, and checks at the time of data clearing of the banknote and coin handling system 100, the check handling apparatus 300, the lobby deposit handling apparatus 400, and the money change handling apparatus 500.

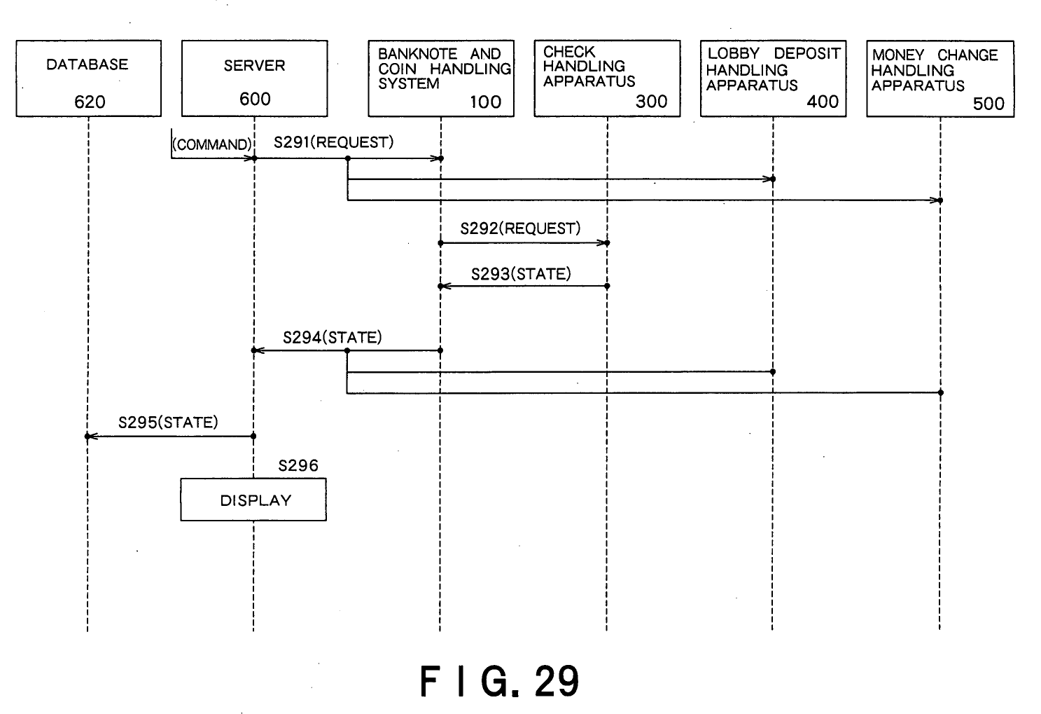

Next, a near-full/near-end management function of the fund management system will be described with reference to FIG. 29. FIG. 29 is a sequence diagram showing an outline of the near-full/near-end management function of the fund management system.

As shown in FIG. 29, when the user issues a command of near-full/near-end inquiry to the server 600, the server 600 transmits a request of the total amount of money and/or total number of banknotes, coins, and checks (total amount of money and/or total number of banknotes, coins, and checks) and a request of the state (near-full, and near-end) to the banknote and coin handling system 100, the lobby deposit handling apparatus 400, and the money change handling apparatus 500 installed at each operation branch (S291). The request of the total amount of money and/or total number of banknotes, coins, and checks and the request of the state include classification (all branches and districts).

As shown in FIG. 29, the banknote and coin handling system 100 transmits a request of state to the check handling apparatus 300 (S292). In response, the check handling apparatus 300 transmits the state of the check handling apparatus 300 to the banknote and coin handling system 100 (S293).

As shown in FIG. 29, each of the banknote and coin handling system 100, the lobby deposit handling apparatus 400, and the money change handling apparatus 500 transmits the total amount of money and/or total number of banknotes, coins, and checks and transmits the state to the server 600 (S294).

As shown in FIG. 29, the server 600 registers the states transmitted from the banknote and coin handling system 100, the lobby deposit handling apparatus 400, and the money change handling apparatus 500 to the database 620 (S295).

As shown in FIG. 29, the server 600 counts the total amount of money and/or total number of banknotes, coins, and checks and counts the state of each of the banknote and coin handling system 100, the check handling apparatus 300, the lobby deposit handling apparatus 400, and the money change handling apparatus 500 according to the request of the total amount of money and/or total number of banknotes, coins, and checks and the state of S291 and displays the count result (S296). For example, the server 600 may display the count result in a list or in a graph, or may display the ones that satisfy predetermined conditions and the ones that do not satisfy the conditions in different colors.

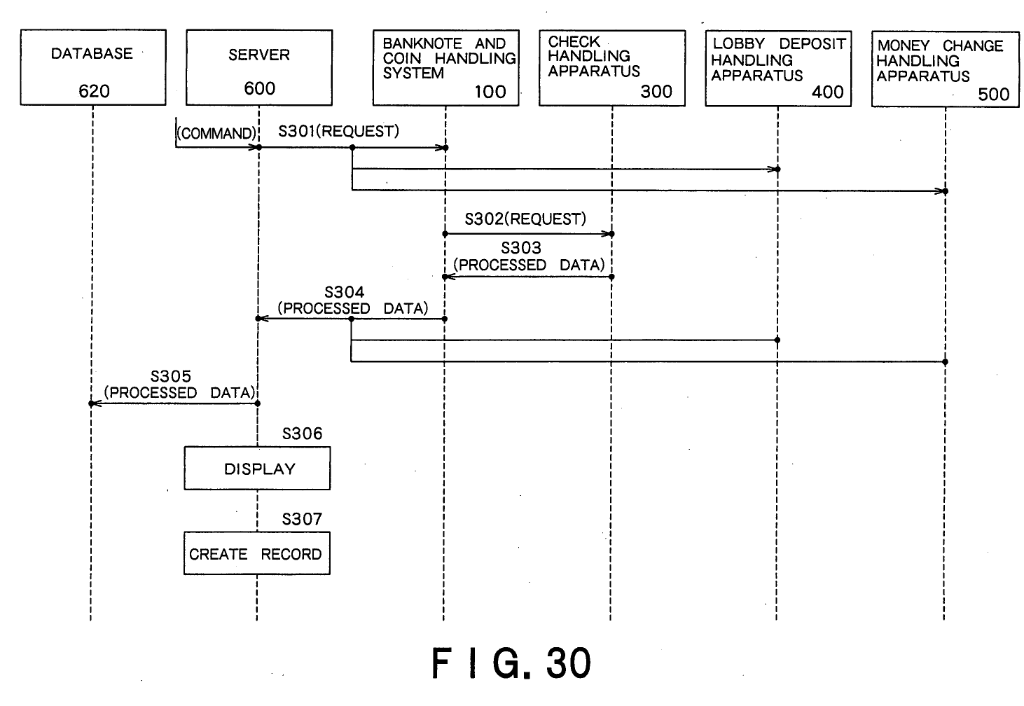

A management table function of the fund management system will now be described with reference to FIG. 30. FIG. 30 is a sequence diagram showing an outline of the management table function of the fund management system.

As shown in FIG. 30, when the user issues a command of management table inquiry to the server 600, the server 600 transmits a request of management table inquiry to the banknote and coin handling system 100, the lobby deposit handling apparatus 400, and the money change handling apparatus 500 installed at each operation branch (S301). The command of management table inquiry includes date, operation branch, and equipment. The processed data includes total deposit, total dispensation, total transfer deposit, total transfer dispensation, total load/collection, total of each item, and brief total.

As shown in FIG. 30, the banknote and coin handling system 100 transmits a request of processed data to the check handling apparatus 300 (S302). In response, the check handling apparatus 300 transmits the processed data of the check handling apparatus 300 to the banknote and coin handling system 100 (S303).

As shown in FIG. 30, each of the banknote and coin handling system 100, the lobby deposit handling apparatus 400, and the money change handling apparatus 500 transmits the processed data to the server 600 (S304). In this case, the banknote and coin handling system 100 transmits the processed data of the check handling apparatus 300 in addition to the processed data of the banknote and coin handling system 100.

As shown in FIG. 30, the server 600 registers the processed data transmitted from the banknote and coin handling system 100, the lobby deposit handling apparatus 400, and the money change handling apparatus 500 to the database 620 (S305).

As shown in FIG. 30, the server 600 displays the management table of each of the banknote and coin handling system 100, the check handling apparatus 300, the lobby deposit handling apparatus 400, and the money change handling apparatus 500 in accordance with the command of management table inquiry of S301 (S306). For example, the server 600 may display, in a list or in a graph, the processed data of the banknote and coin handling system 100, the check handling apparatus 300, the lobby deposit handling apparatus 400, and the money change handling apparatus 500.

As shown in FIG. 30, the server 600 creates a record based on the processed data of S304 (S307). The record includes the latest total amount of money and/or total number of banknotes, coins, and checks of the banknote and coin handling system 100, the check handling apparatus 300, the lobby deposit handling apparatus 400, and the money change handling apparatus 500 that are necessary for a closing process.

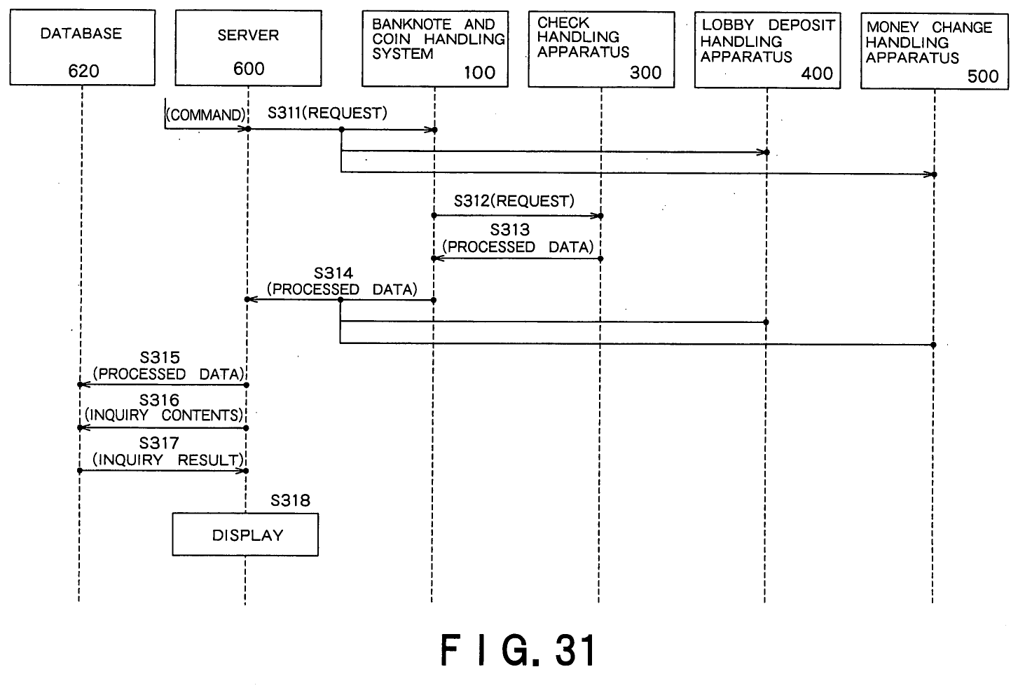

Next, a data inquiry function of the fund management system will be described with reference to FIG. 31. FIG. 31 is a sequence diagram showing an outline of the data inquiry function of the fund management system.

As shown in FIG. 31, when the user issues a command of data inquiry to the server 600, the server 600 transmits a request of processed data to the banknote and coin handling system 100, the lobby deposit handling apparatus 400, and the money change handling apparatus 500 installed at each operation branch (S311). The command of data inquiry includes date, operation branch, and equipment. The processed data includes inquiry contents (total inquiry of person in charge, data search, door open inquiry, and journal data inquiry) of total deposit, total dispensation, total transfer deposit, total transfer dispensation, and total load/collection. The data search is a function of searching the processed data of the equipment in accordance with the conditions. The door open inquiry is a function of inquiring the door open histories of the equipment. The journal data inquiry is a function of inquiring the journal datas of the equipment.

As shown in FIG. 31, the banknote and coin handling system 100 transmits a request of processed data to the check handling apparatus 300 (S312). In response, the check handling apparatus 300 transmits the processed data of the check handling apparatus 300 to the banknote and coin handling system 100 (S313).

As shown in FIG. 31, the banknote and coin handling system 100, the lobby deposit handling apparatus 400, and the money change handling apparatus 500 transmit the processed data to the server 600 (S314). The banknote and coin handling system 100 transmits the processed data of the check handling apparatus 300 in addition to the processed data of the banknote and coin handling system 100.

As shown in FIG. 31, the server 600 registers the processed data transmitted from the banknote and coin handling system 100, the lobby deposit handling apparatus 400, and the money change handling apparatus 500 to the database 620 (S315).

As shown in FIG. 31, the server 600 transmits the command of management table inquiry (inquiry contents) of S311 to the database 620 (S316) and acquires the inquiry result from the database 620 (S317).

As shown in FIG. 31, the server 600 displays the inquiry result acquired from the database 620 (S318).

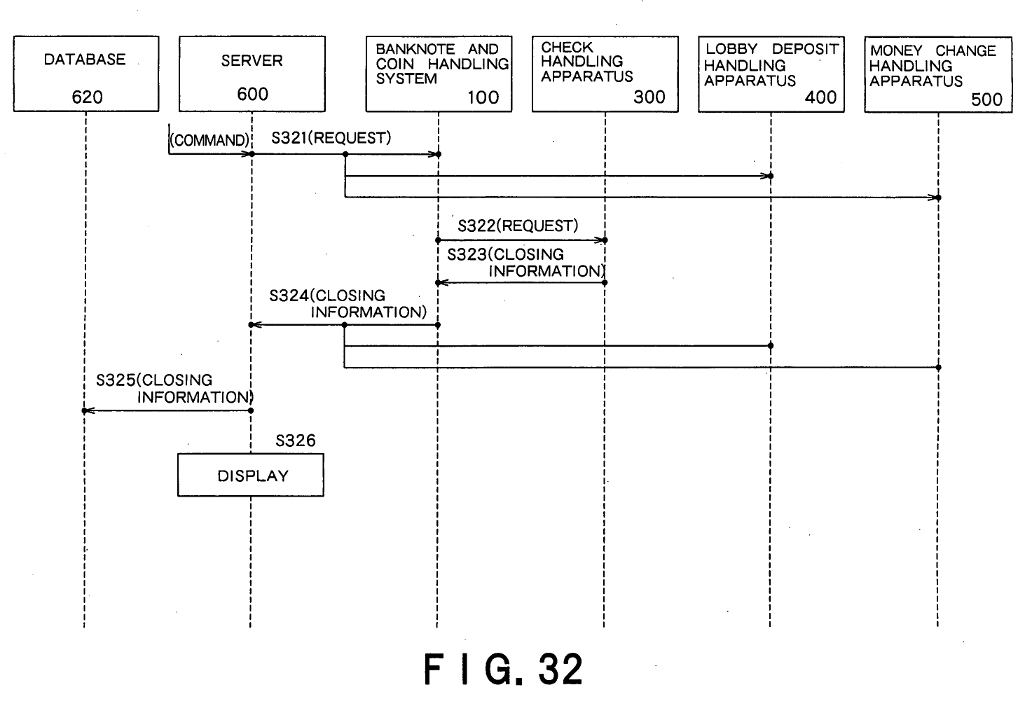

A closing management function of the fund management system will be described with reference to FIG. 32. FIG. 32 is a sequence diagram showing an outline of the closing management function of the fund management system.

As shown in FIG. 32, when the user issues a command of closing management to the server 600, the server 600 transmits a request of closing information to the banknote and coin handling system 100, the lobby deposit handling apparatus 400, and the money change handling apparatus 500 (S321) installed at each operation branch. The command of closing management includes classification (all branches and districts) and date. The closing information includes closing time, progress of the process in the operation branch, matching status of total amount of money and/or total number of banknotes, coins, and checks and calculation amount of money of the equipment, and data clear status of the equipment.

As shown in FIG. 32, the banknote and coin handling system 100 transmits a request of closing information to the check handling apparatus 300 (S322). In response, the check handling apparatus 300 transmits the closing information of the check handling apparatus 300 to the banknote and coin handling system 100 (S323).

As shown in FIG. 32, the banknote and coin handling system 100, the lobby deposit handling apparatus 400, and the money change handling apparatus 500 transmit the closing information to the server 600 (S324). In this case, the banknote and coin handling system 100 transmits the closing information of the check handling apparatus 300 in addition to the closing information of the banknote and coin handling system 100.

As shown in FIG. 32, the server 600 registers the closing information transmitted from the banknote and coin handling system 100, the lobby deposit handling apparatus 400, and the money change handling apparatus 500 to the database 620 (S325).

As shown in FIG. 32, the server 600 displays the closing information of each of the banknote and coin handling system 100, the check handling apparatus 300, the lobby deposit handling apparatus 400, and the money change handling apparatus 500 in accordance with the command of closing management of S321 (S326). For example, the server 600 displays, in a list, the closing situation and the closing time of each of the banknote and coin handling system 100, the check handling apparatus 300, the lobby deposit handling apparatus 400, and the money change handling apparatus 500.

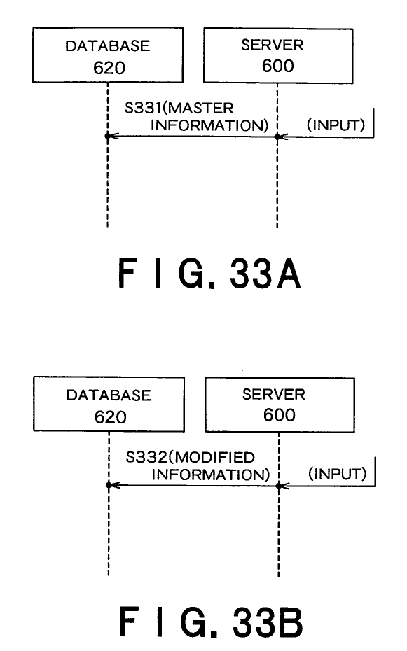

An operation management function of the fund management system will be described with reference to FIG. 33A and FIG. 33B. FIG. 33A is a sequence diagram showing an outline of the operation management function (a management function of master information) of the fund management system. FIG. 33B is a sequence diagram showing an outline of the operation management function (a modification function of a data) of the fund management system.

As shown in FIG. 33A, in the case of the management of master information, when the user inputs master information to the server 600, the server 600 registers the master information to the database 620 (S331). The master information includes person in charge having the operation right of the fund management system, operation branch, equipment, conditions of near-full/near-end, and name (item, classification, denomination, mode, balance, and balance on hand).

As shown in FIG. 33B, in the case of the modification of the data stored in the database 620, when the user inputs modified information to the server 600, the server 600 modifies the data stored in the database 620 using the modified information (S332). The modified information includes the total amount of money and/or total number of banknotes, coins, and checks of the equipment. For example, the user inputs the modified information according to the information acquired by FAX or the like when a failure occurs in the network 800.

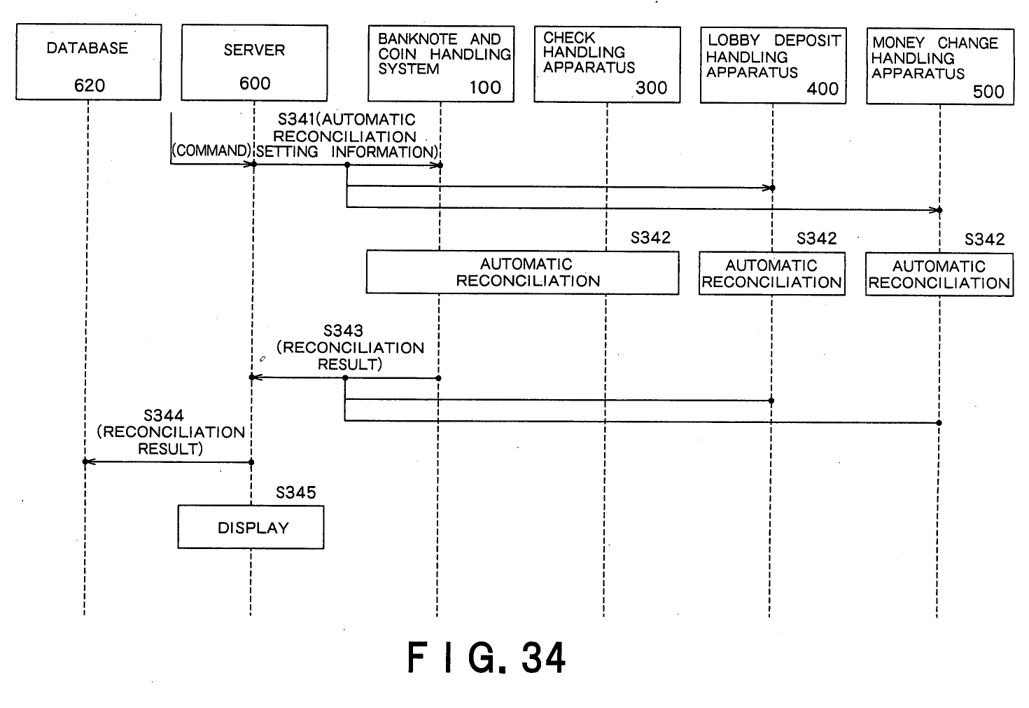

An automatic reconciliation function of the fund management system will now be described with reference to FIG. 34. FIG. 34 is a sequence diagram showing an outline of the automatic reconciliation function of the fund management system.

As shown in FIG. 34, when the user issues a command of automatic reconciliation to the server 600, the server 600 transmits automatic reconciliation setting information to the banknote and coin handling system 100, the lobby deposit handling apparatus 400, and the money change handling apparatus 500 installed at each operation branch (S341). The command of the automatic reconciliation includes classification (all branches, districts, operation branches, and equipment), execution setting (set date clear, all equipments clear, specified equipment setting, and all equipments setting), and execution date setting (from today to nine days later).

As shown in FIG. 34, the banknote and coin handling system 100, the lobby deposit handling apparatus 400, and the money change handling apparatus 500 performs automatic reconciliation according to automatic reconciliation setting information sent from the server 600 (S342). The banknote and coin handling system 100 performs automatic reconciliation of the check handling apparatus 300 in addition to the automatic reconciliation of the banknote and coin handling system 100.

As shown in FIG. 34, each of the banknote and coin handling system 100, the lobby deposit handling apparatus 400, and the money change handling apparatus 500 transmits the reconciliation result to the server 600 (S343).

As shown in FIG. 34, the server 600 registers the reconciliation results sent from the banknote and coin handling system 100, the lobby deposit handling apparatus 400, and the money change handling apparatus 500 to the database 620 (S344).

As shown in FIG. 34, the server 600 displays the reconciliation results of the banknote and coin handling system 100, the check handling apparatus 300, the lobby deposit handling apparatus 400, and the money change handling apparatus 500 (S345). For example, the server 600 displays that the reconciliation result is normal, caution necessary, or abnormal, as well as the initial total amount of money and/or total number of banknotes, coins, and checks and the reconciled total amount of money and/or total number of banknotes, coins, and checks.

According to the fund management system of the present invention, the server 600 installed at the center realizes the management function of the total amount of money and/or total number of banknotes, coins, and checks, the near-full/near-end management function, the management table function, the data inquiry function, the closing management function, the operation management function, and the automatic reconciliation function of the banknote and coin handling system 100, the lobby deposit handling apparatus 400, the money change handling apparatus 500, and the check handling apparatus 300 installed at each operation branch. Therefore, the fund management system realizes unified management of all funds of the operation branches.

What is claimed is:

1. A fund management system comprising:
a banknote and coin handling system which handles a banknote and a coin;
a check handling apparatus which handles a check;
a lobby deposit handling apparatus which executes a lobby deposit process;
a money change handling apparatus which changes the money; and
a server which manages the banknote and coin handling system, the check handling apparatus, the lobby deposit handling apparatus, and the money change handling apparatus.

2. The fund management system according to claim 1, wherein the check handling apparatus comprising:
a storage unit provided with a stacker; and
a memory which stores check data of the check stored in the storage unit;
the server which acquires the check data stored in the memory.

3. The fund management system according to claim 2, wherein the check handling apparatus further comprising a post which stores a medium that cannot be stored in the storage unit;
the check data includes total amount of money or total number of checks of the post.

4. The fund management system according to claim 2, wherein the check data includes at least one of total amount of money or total number of checks of the storage unit, and amount of money or number of checks of each check.

5. The fund management system according to claim 2, wherein the check handling apparatus further comprising a reading unit which reads image information of the check;
the check data includes the image information read by the reading unit.

6. The fund management system according to claim 1, wherein the server acquires a state of the check handling apparatus.

7. The fund management system according to claim 1, wherein the server acquires processed data of the check handling apparatus.

8. The fund management system according to claim 1, wherein the server acquires closing information of the check handling apparatus.

9. The fund management system according to claim 1, wherein the server acquires a reconciliation result of the check handling apparatus.

10. The fund management system according to claim 2, wherein the storage unit comprising a plurality of stackers which store the checks by type.

11. The fund management system according to claim 10, wherein the check data includes at least one of total amount of money or total number of checks of each stacker, total amount of money or total number of checks of all stackers, and amount of money or number of checks of each check.
